(19) United States
(12) Patent Application Publication
(10) Pub. No.: US 2023/0244078 A1
(43) Pub. Date: Aug. 3, 2023

(54) OPTICAL MEMBER, OPTICAL DEVICE, IMAGING APPARATUS, AND DISPLAY APPARATUS

(71) Applicant: CANON KABUSHIKI KAISHA, Tokyo (JP)

(72) Inventors: JUMPEI HAYASHI, Kanagawa (JP); HIROAKI KOBAYASHI, Kanagawa (JP); MASANORI ABE, Kanagawa (JP); MASAAKI NAKABAYASHI, Kanagawa (JP); HIROYUKI TANAKA, Kanagawa (JP)

(21) Appl. No.: 18/160,073

(22) Filed: Jan. 26, 2023

(30) Foreign Application Priority Data
Jan. 28, 2022 (JP) 2022-012049
Jan. 28, 2022 (JP) 2022-012050
Jan. 28, 2022 (JP) 2022-012051
Jan. 28, 2022 (JP) 2022-012052
Dec. 19, 2022 (JP) 2022-202518
Dec. 19, 2022 (JP) 2022-202519
Dec. 19, 2022 (JP) 2022-202520
Dec. 19, 2022 (JP) 2022-202521

(51) Int. Cl. G02B 27/01; G02B 1/11; F21V 8/00; G02B 7/14; G02B 5/08

(52) U.S. Cl. CPC G02B 27/01; G02B 1/11; G02B 6/0005; G02B 7/14; G02B 5/0808; G02B 2027/0138; G02B 2027/0169; G02B 2027/0112

(57) ABSTRACT

An optical member includes a base material having a front surface, and an antireflection film provided on the front surface of the base material and including a resin portion and a deformed fiber bound to the resin portion, wherein the antireflection film includes a protruding portion including the deformed fiber, on a surface of the resin portion that is on an opposite side of a side of the base material, wherein the front surface of the base material includes a protrusion portion, and wherein the protruding portion is provided above the protrusion portion.

### BACKGROUND

### Field of the Disclosure

The present disclosure relates to an optical member, an optical device, an imaging apparatus, and a display apparatus.

### Description of the Related Art

It has been known that unnecessary reflected light or scattering light that is called stray light is generated in a casing of a device or an apparatus including an optical system with at least one lens inside the casing. If the stray light is generated in the casing, flare or ghost is generated in a lens barrel or a camera. This causes a decline in quality of a captured image. In a head-up display, the generated stray light causes a decline in quality of a generated image. Japanese Patent Application Laid-Open No. 2020-8843 discusses an optical member intended to decrease a reflectance in a casing. The optical member includes an antireflection film in which resin contains deformed fibers. Japanese Patent Application Laid-Open No. 2011-64737 discusses an optical system component including a paint film including fine particles with a plurality of types of shapes. Japanese Patent Application Laid-Open 2021-196580 discusses a head-up display apparatus including a resin member having a laser textured surface that has been designed for the purpose of suppressing the generation of stray light to be generated on an inner wall surface of a casing.

Nevertheless, in the optical system component discussed in Japanese Patent Application Laid-Open No. 2011-64737, a reflection reduction effect of the antireflection film may be improved. The quality of an image obtained by the head-up display discussed in Japanese Patent Application Laid-Open No. 2021-196580 may also be improved.

### SUMMARY

According to an aspect of the present disclosure, an optical member includes a base material having a front surface, and an antireflection film provided on the front surface of the base material and including a resin portion and a deformed fiber bound to the resin portion, wherein the antireflection film includes a protruding portion including the deformed fiber, on a surface of the resin portion that is on an opposite side of a side of the base material, wherein the front surface of the base material includes a protrusion portion, and wherein the protruding portion is provided above the protrusion portion.

Further features of the present disclosure will become apparent from the following description of embodiments with reference to the attached drawings.

### BRIEF DESCRIPTION OF THE DRAWINGS

FIGS. 1A and 1B are schematic diagrams illustrating an embodiment of an optical member according to a first embodiment.

FIG. 2A is a plan view of a deformed fiber included in an antireflection film included in the optical member according to the first embodiment. FIG. 2B is a cross-sectional view of the deformed fiber included in the antireflection film included in the optical member according to the first embodiment.

FIGS. 3A and 3B are schematic diagrams illustrating an embodiment of an optical member according to a second embodiment.

FIGS. 4A and 4B are schematic diagrams illustrating an embodiment of an optical member according to a fourth embodiment.

FIGS. 5A and 5C are plan views of a deformed fiber included in an antireflection film included in the optical member according to the fourth embodiment. FIGS. 5B and 5D are cross-sectional views of the deformed fiber included in the antireflection film included in the optical member according to the fourth embodiment.

FIGS. 6A and 6B are schematic diagrams illustrating an embodiment of an optical member according to a fifth embodiment.

FIG. 7 is a schematic diagram illustrating an embodiment of an imaging apparatus according to a seventh embodiment.

FIG. 8 is a schematic diagram illustrating an embodiment of a display apparatus according to an eighth embodiment.

FIG. 9 is a schematic diagram illustrating an embodiment of a display apparatus according to a ninth embodiment.

FIGS. 10A and 10B are schematic diagrams illustrating an antireflection film of the display apparatus according to the ninth embodiment.

FIG. 11A is a plan view of a deformed fiber included in the antireflection film of the display apparatus according to the ninth embodiment. FIG. 11B is a cross-sectional view of the deformed fiber included in the antireflection film of the display apparatus according to the ninth embodiment.

FIGS. 12A and 12B are schematic diagrams illustrating a modified example of the display apparatus according to the ninth embodiment.

FIG. 13 is a schematic diagram illustrating an embodiment of a display apparatus according to a tenth embodiment.

FIG. 14 is a schematic diagram illustrating an embodiment of a display apparatus according to an eleventh embodiment.

FIGS. 15A, 15B, and 15C are schematic diagrams illustrating an antireflection film of the display apparatus according to the eleventh embodiment.

FIG. 16A is a plan view of a deformed fiber included in the antireflection film of the display apparatus according to the eleventh embodiment. FIG. 16B is a cross-sectional view of the deformed fiber included in the antireflection film of the display apparatus according to the eleventh embodiment.

FIG. 17 is a schematic diagram illustrating an embodiment of a display apparatus according to a twelfth embodiment.

FIGS. 18A, 18B, 18C, 18D, and 18E are schematic diagrams illustrating a modified example of a deformed fiber.

FIGS. 19A, 19B, 19C, and 19D are schematic diagrams illustrating a modified example of an optical member.

### DESCRIPTION OF THE EMBODIMENTS

### (Optical Member)

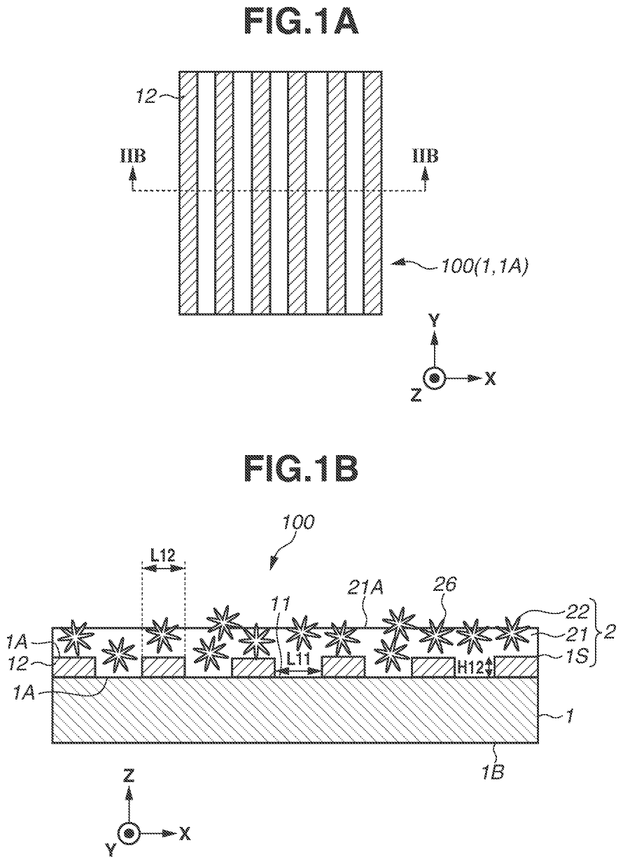

FIGS. 1A and 1B are schematic diagrams illustrating an embodiment of an optical member according to a first embodiment. FIG. 1A is a plan view and FIG. 1B is a cross-sectional view of an optical member 100 that is taken along an IIB-IIB line in FIG. 1A. For the sake of explanatory convenience, the illustration of an antireflection film 2 is omitted in FIG. 1A.

In FIG. 1B, a Z-axis extends in a direction in which the antireflection film 2 is stacked on a base material 1. In addition, an X-axis extends in a direction in which protrusion portions 12 are adjacently arranged. In addition, a direction orthogonal to the Z-axis and the X-axis is set as a Y-axis. In an XYZ coordinate system including coordinate axes defined in this manner, a direction extending along the X-axis is referred to as an X direction, a direction extending along the Y-axis is referred to as a Y direction, and a direction extending along the Z-axis is referred to as a Z direction.

The optical member 100 includes the base material 1 and the antireflection film 2.

The base material 1 has a first surface 1A being a front surface of the base material 1, and a second surface 1B being a rear surface of the base material 1, and being a surface on the opposite side of the first surface 1A of the base material 1. The antireflection film 2 is provided on the first surface 1A of the base material 1 in close contact with the first surface 1A of the base material 1. The first surface 1A of the base material 1 has an irregular structure. The irregular structure includes a plurality of protrusion portions 12 and recess portions 11. FIGS. 1A and 1B illustrate six protrusion portions 12 and five recess portions 11, but the number of protrusion portions 12 and the number of recess portions 11 are not limited to these numbers, and desired numbers can be appropriately selected.

At least one deformed fiber 22 is provided above at least one of the plurality of protrusion portions 12. It is desirable that the at least one deformed fiber 22 is provided in contact with the protrusion portion 12. A height and a length of the protrusion portions 12 are denoted by H12 and L12, respectively. The height H12 of the protrusion portions 12 corresponds to a distance in the Z direction from a first reference 1S to the recess portion 11. The first reference 1S refers to a position at which the protrusion portion 12 and the antireflection film 2 have contact with each other in the protrusion portion 12 above which the deformed fiber 22 is provided. The height H12 of all the protrusion portions 12 need not be constant. In FIG. 1B, the length L12 of the protrusion portions 12 indicates a length in the X direction of the protrusion portions 12, but may be a length in the Y direction. In other words, the length L12 of the protrusion portions 12 indicates a length in a direction orthogonal to the Z direction being a height direction of the protrusion portions 12, and indicates a smallest length of the protrusion portions 12 when the optical member 100 is planarly viewed from the Z direction. The length L12 of all the protrusion portions 12 need not be constant, either.

The recess portion 11 is formed at a position at which the recess portion 11 is recessed in a direction of getting farther away from the antireflection film 2, with respect to the first reference 1S. The deformed fiber 22 may be provided above the recess portion 11. A length L11 of the recess portions 11 is a largest interval between two adjacent protrusion portions 12. The length L11 of all the recess portions 11 need not be constant.

The material of the base material 1 is not specifically limited, and metal or resin can be used. Examples of metal include aluminum, aluminum alloy, titanium alloy, stainless, magnesium, and magnesium alloy. From the aspect of cost and durability, aluminum alloy or magnesium alloy is desirably used. Examples of resin include polycarbonate resin, acrylic resin, acrylonitrile butadiene styrene (ABS) resin, and fluorine resin.

A method for providing the irregular structure on the first surface 1A of the base material 1 is not specifically limited, but it is desirable that the irregular structure is formed by emboss processing. In other words, it is desirable that the first surface 1A of the base material 1 is an embossed surface formed by emboss processing. The emboss processing is processing of forming fine irregularities on the surface of a mold, when a molded component of metal or resin is obtained using a mold, and transferring the fine irregularities on the surface of the mold onto the surface of the molded component. The irregularities on the surface of the mold can be formed by chemical etching, sandblasting, or laser processing, for example. Because the emboss processing can form irregularities finer than those formed by mechanical processing, the deformed fiber 22 becomes less likely to be buried in a resin portion 21 as compared with rough irregularities formed by mechanical processing. In other words, the deformed fiber 22 becomes more likely to protrude from a first surface 21A of the resin portion 21. The type of grains formed by the emboss processing (configuration of the embossed surface) is not specifically limited. For example, leather texture, matt finish, wood texture, a textile pattern, or a geometric pattern can be used.

The antireflection film 2 includes the resin portion 21 and a plurality of deformed fibers 22. The antireflection film 2 is provided on the first surface 1A being the front surface of the base material 1.

The resin portion 21 has the first surface 21A being the front surface of the resin portion 21, contains at least a part of the deformed fibers 22, and includes a protruding portion 26 protruding from the first surface 21A of the resin portion 21. In the first embodiment, the protruding portion 26 is formed by the deformed fiber 22 protruding from the first surface 21A of the resin portion 21. The protruding portion 26 is provided above the protrusion portion 12. In other words, in a planar view, the protruding portion 26 is provided at a position overlapping the protrusion portion 12. The first surface 21A of the resin portion 21 refers to a surface of the resin portion 21 that is on the opposite side of a surface being in contact with the base material 1 (base material side). The type of resin included in the resin portion 21 is not specifically limited. For example, the type of resin can be selected from acrylic resin, urethane resin, epoxy resin, and a combination of these. In addition, either solvent soluble resin or reactive curable resin may be used. To enhance absorption efficiency of light rays, the resin portion 21 is desirably dyed black using black dyeing material. The type of black dyeing material is not specifically limited. Organic material such as dyeing ink, metal such as nickel, cobalt, or copper, or inorganic material such as carbon black can be selected. The black refers to color having light absorbability within the entire range of a light wavelength range from 380 nm to 780 nm. In addition, the resin portion 21 desirably has a degree of blackness equal to or larger than 0.7. The degree of blackness is indicated by a ratio of a maximum absorptance with respect to a minimum absorptance in the light wavelength range from 380 nm to 780 nm.

A thickness of the resin portion 21 is not specifically limited, but the thickness desirably falls within a range from 10 μm to 500 μm. If the thickness of the resin portion 21 falls within the range, it is possible to achieve both of a good antireflection function and peel resistance. If the thickness of the resin portion 21 becomes smaller than 10 μm, there is concern that the antireflection function fails to be obtained sufficiently. On the other hand, if the thickness of the resin portion 21 exceeds 500 μm, film thickness unevenness is easily generated. If the film thickness unevenness becomes larger, the antireflection film 2 becomes more likely to peel from the base material 1. More desirably, the thickness of the resin portion 21 falls within a range from 20 μm to 200 μm.

The plurality of deformed fibers 22 is bound to the resin portion 21. It is desirable that at least one of the plurality of deformed fibers 22 is provided above the protrusion portion 12. In the present disclosure, a deformed fiber refers to a fiber having a cross-sectional shape in a direction vertical to a length direction (fiber axis direction) that is other than a circle, an ellipse, and a convex polygon in which all inner angles are smaller than 180°. By the deformed fiber 22 being provided above the protrusion portion 12, the deformed fiber 22 becomes less likely to be buried in the resin portion 21, and becomes more likely to protrude from the first surface 21A of the resin portion 21. In addition, by the deformed fiber 22 protruding from the first surface 21A of the resin portion 21, even if a light ray deviating from an optical path (for example, a light ray with a high incidence angle exceeding 80 degrees) enters the first surface 21A of the resin portion 21, the light ray becomes less likely to return to the optical path by impinging on the deformed fiber 22. Thus, the optical member of the first embodiment has a low reflectance and can reduce an amount of stray light in an optical system. The optical member can accordingly reduce the influence of stray light that is exerted on desired performance of a device.

The plurality of deformed fibers 22 may be provided above the recess portions 11. In this case, it is desirable that the number of deformed fibers 22 provided above the protrusion portions 12 is larger than the number of deformed fibers 22 provided above the recess portions 11. In addition, it is desirable that a volume of the deformed fibers 22 provided above the protrusion portions 12 is larger than a volume of the deformed fibers 22 provided above the recess portions 11. This is because the deformed fibers 22 provided above the protrusion portions 12 have a larger volume of portions protruding from the first surface 21A of the resin portion 21, and can accordingly increase an amount of light rays that become less likely to return to an optical path by impinging on the deformed fibers 22.

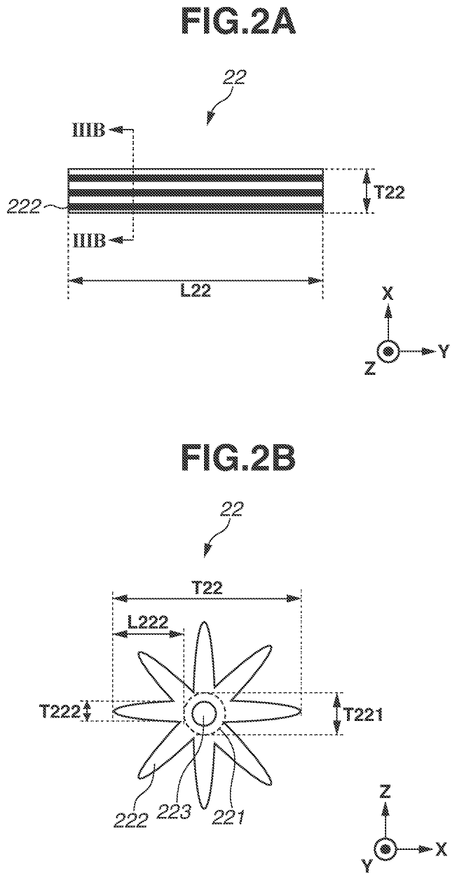

FIGS. 2A and 2B are schematic diagrams of a deformed fiber usable in the optical member of the present embodiment. FIG. 2A is a plan view and FIG. 2B is a cross-sectional view of the deformed fiber 22 that is taken along an line in FIG. 2A. The deformed fiber 22 includes a core portion 221 and a plurality of leg portions 222 extending from the core portion 221. The core portion 221 is a portion drawn by a dotted line in FIG. 2B, and its cross-sectional shape is a circular shape. Nevertheless, the cross-sectional shape of the core portion 221 need not always be a circular shape, and may be a rectangular shape. In a case where the cross-sectional shape of the core portion 221 is a circle, a thickness T221 of the core portion 221 (length of a cross section in a direction vertical to a length direction of the deformed fiber 22) indicates a diameter of the circle. In a case where the cross-sectional shape of the core portion 221 is a polygon, the thickness T221 indicates a diameter of an inscribed circle of the polygon. In a case where the cross-sectional shape of the core portion 221 is an ellipse, the thickness T221 indicates a diameter on a semimajor axis side. The core portion 221 may include a hole 223.

The leg portions 222 extend from the core portion 221, and are made of the same material as the core portion 221. In FIG. 2B, the number of leg portions 222 is eight, but the number of leg portions 222 is not limited to eight. Among regions of the deformed fiber 22, the protruding portion 26 protruding from the first surface 21A of the resin portion 21 desirably corresponds to the leg portions 222. This is because, by the plurality of leg portions 222 protruding from the first surface 21A, light rays entering a space between two leg portions can be caused to diffuse and made less likely to return to an optical path. To diffuse light rays more efficiently between leg portions in the deformed fiber 22, it is desirable that the number of leg portions 222 is three or more and eight or less. As an example of a commercially available deformed fiber including eight leg portions, there is Octa® manufactured by TEIJIN FRONTIER CO., LTD. It is difficult to manufacture a deformed fiber including nine or more leg portions.

A length L222 of the leg portions 222 desirably falls within a range from 5 μm to 20 μm. If the length L222 of the leg portions 222 falls within the range, a reflectance reduction effect becomes larger. If the length L222 of the leg portions 222 is smaller than 5 μm, a length by which the leg portion 222 protrudes from the first surface 21A of the resin portion 21 (a length of the protruding portion 26) becomes shorter, and light reflection between the plurality of leg portions 222 does not occur sufficiently. Accordingly, there is concern that the reflectance reduction effect becomes insufficient. On the other hand, if the length L222 of the leg portions 222 is larger than 20 μm, the leg portions 222 incline or collapse, and a sufficient amount of light rays cannot enter a space between the plurality of leg portions 222. Accordingly, there is concern that the reflectance reduction effect becomes insufficient. More desirably, the length L222 of the leg portions 222 falls within a range from 5 μm to 12.5 μm.

A thickness T222 of the leg portions 222 desirably falls within a range from 2 μm to 6 μm. If the thickness T222 of the leg portions 222 falls within the range, a reflectance reduction effect becomes larger. If the thickness T222 of the leg portions 222 is smaller than 2 μm, the leg portions 222 incline or collapse, and a sufficient amount of light cannot enter a space between the plurality of leg portions 222. Accordingly, there is concern that the reflectance reduction effect becomes insufficient. On the other hand, if the thickness T222 of the leg portions 222 is larger than 6 μm, an interval between the plurality of leg portions 222 becomes smaller, and light reflection between the plurality of leg portions 222 does not occur sufficiently. Accordingly, there is concern that the reflectance reduction effect becomes insufficient.

A thickness T22 of the deformed fiber 22 is desirably larger than the height H12 of the protrusion portion 12. This is to enable the deformed fiber 22 provided above the recess portion 11 to easily protrude from the first surface 21A of the resin portion 21.

The thickness T22 of the deformed fiber 22 refers to a length of a cross section in a direction vertical to a length direction of the deformed fiber 22, and refers to a length of a cross section orthogonal to a fiber axis. In other words, the thickness T22 of the deformed fiber 22 is a maximum value of a sum of lengths in a cross-section direction of the core portion 221 and the leg portions 222.

The thickness T22 of the deformed fiber 22 is desirably smaller than the length L12 of the protrusion portions 12. This is to enable the deformed fiber 22 to be easily provided above the protrusion portion 12, and to enable the deformed fiber 22 to easily protrude from the first surface 21A of the resin portion 21. The thickness T22 of the deformed fiber 22 desirably falls within a range from 10 μm to 50 μm.

A length L22 of the deformed fiber 22 is desirably longer than the height H12 of the protrusion portions 12. This is to enable the deformed fiber 22 provided above the recess portion 11 to easily protrude from the first surface 21A of the resin portion 21.

The length L22 of the deformed fiber 22 desirably falls within a range from 0.2 mm to 1.0 mm. If the length L22 of the deformed fiber 22 falls within the range, the antireflection function improves. If the length L22 of the deformed fiber 22 is shorter than 0.2 mm, a higher proportion of a cut surface of the deformed fiber 22 that does not include the antireflection function protrudes from the first surface 21A of the resin portion 21. Accordingly, there is concern that the antireflection function becomes insufficient. On the other hand, if the length L22 of the deformed fiber 22 is longer than 1.0 mm, there is concern that it becomes difficult to cause the leg portions 222 of the deformed fiber 22 to protrude from the first surface 21A of the resin portion 21 when the antireflection film 2 is formed. The length L22 of the deformed fiber 22 can be set to a desired length by cutting the deformed fiber 22 using a cutting machine.

An aspect ratio being a ratio (L22/T22) of the length L22 of the deformed fiber 22 with respect to the thickness T22 of the deformed fiber 22 desirably falls within a range from 4 to 100. If the aspect ratio falls within the range, it becomes easier to cause the leading end of the leg portion 222 of the deformed fiber 22 to protrude from the first surface 21A of the resin portion 21 when the antireflection film 2 is formed. Nevertheless, if the aspect ratio becomes smaller than 4 and the shape of the deformed fiber 22 gets closer to an isotropic shape, a cut surface of the deformed fiber 22 becomes more likely to protrude from the first surface 21A of the resin portion 21. Accordingly, there is concern that the antireflection function becomes insufficient. On the other hand, if the aspect ratio becomes larger than 100, it becomes difficult to control the orientation of the deformed fiber 22. Accordingly, there is concern that it becomes difficult for the leading end of the leg portion 222 to protrude from the first surface 21A of the resin portion 21.

The material of the deformed fiber 22 is not specifically limited. For example, the material can be selected from polyester, nylon, acrylic, polypropylene, rayon, polyethylene, polyurethane, cotton linen, knitted wool, and a combination of these. To enhance the performance of the antireflection film 2, processing, light resistance processing, softening processing, or fading resistance processing may be performed on the deformed fibers 22.

A content of the deformed fibers 22 in the antireflection film 2 desirably falls within a range from 33 parts by mass to 67 parts by mass. If the content of the deformed fibers 22 falls within the range, the antireflection film 2 can achieve both of optical performance and manufacturing easiness. If the content of the deformed fibers 22 is smaller than 33 parts by mass, the number of the deformed fibers 22 protruding from the first surface 21A of the resin portion 21 becomes smaller. Accordingly, there is concern that the reflectance reduction effect becomes insufficient. On the other hand, if the content of the deformed fibers 22 exceeds 67 parts by mass, when the antireflection film 2 is formed by spray painting, the leading end of a spray nozzle becomes highly likely to be clogged, and there is concern that manufacturing becomes difficult.

A method for providing the antireflection film 2 on the irregular structure of the first surface 1A of the base material 1 is not specifically limited. Examples of the method include brush painting, spray painting, dip painting, and transfer. All of these methods are methods that use, as raw material, a paint containing uncured resin being a precursor of the resin portion 21, the deformed fibers 22, and an arbitrary solvent.

Among these methods, it is desirable to execute spray painting using the above-described paint, from the aspect of being superior in conformance to the shape of the first surface 1A of the base material 1. In addition, a method for obtaining the antireflection film 2 by curing the paint is not specifically limited, either. The paint may be dried at room temperature (for example, 23° C.±2° C.), curing may be promoted by heat, or ultraviolet light may be emitted onto the paint.

As described above, according to the optical member 100 of the first embodiment, the protruding portion 26 including the deformed fiber 22 is provided above the protrusion portion 12 of the base material 1. Thus, by employing such a configuration, a reflectance of the optical member 100 becomes lower, and even if a light ray deviating from an optical path is reflected on the first surface 21A of the resin portion 21, the light ray can be made less likely to return to the optical path by impinging on the deformed fiber 22 of the protruding portion 26. Thus, according to the optical member 100 of the first embodiment, because an amount of stray light generated in an optical system is reduced, it is possible to decrease the influence of stray light that is exerted on desired performance of a device.

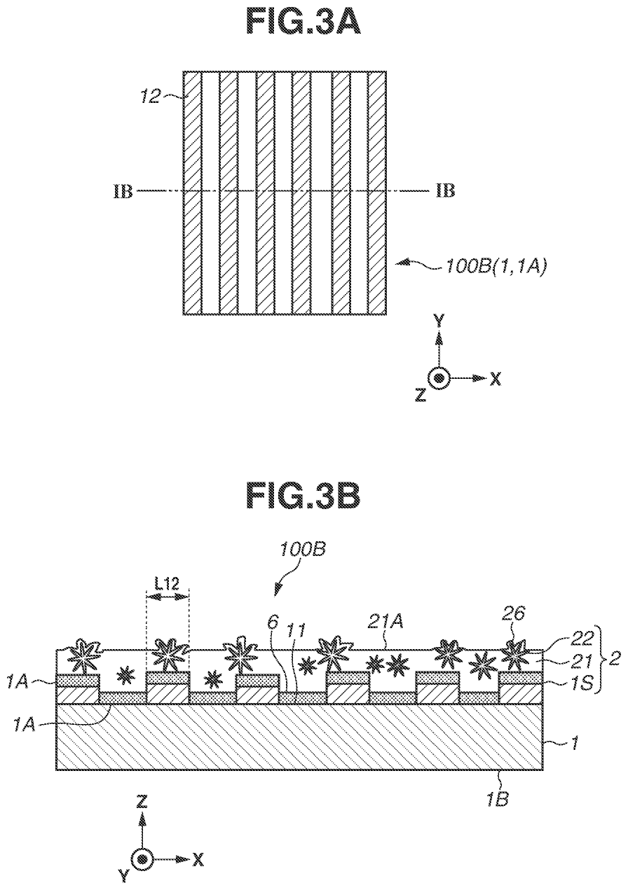

FIGS. 3A and 3B are schematic diagrams illustrating an embodiment of an optical member according to a second embodiment. FIG. 3A is a plan view and FIG. 3B is a cross-sectional view of an optical member 100B that is taken along an IB-IB line in FIG. 3A. The optical member according to the second embodiment differs from that of the first embodiment in that an intermediate layer 6 is provided between the base material 1 and the antireflection film 2, and the deformed fiber 22 is covered with the resin portion 21 in the protruding portion 26. Hereinafter, the optical member of the second embodiment will be described mainly based on a point different from that of the first embodiment.

The intermediate layer 6 is a primer layer provided on the first surface 1A of the base material 1, for example, to enhance adhesiveness with the antireflection film 2. The material of the primer layer is not specifically limited. Examples of the material include epoxy resin, urethane resin, acrylic resin, silicone resin, and fluorine resin. The purpose of providing the intermediate layer 6 is not limited to the purpose of enhancing adhesiveness. The intermediate layer 6 may be provided for another purpose such as a purpose of preventing reaction between the first surface 1A of the base material 1 and a precursor of the antireflection film 2 in a manufacturing process. The primer layer may be provided only in the protrusion portions 12, and may be prevented from being provided in the recess portions 11. When the primer layer is provided on both of the protrusion portions 12 and the recess portions 11, the primer layer is desirably provided in such a manner as not to bury an irregular structure thereof. The thickness of the primer layer is not specifically limited, but is desirably a thickness that does not bury the protrusion portions 12. When the primer layer is provided with a thickness larger than the height of the protrusion portions 12, the primer layer is desirably provided in such a manner as to reflect an irregular shape of the first surface 1A of the base material 1.

The deformed fiber 22 is covered with the resin portion 21 in the protruding portion 26. Because the optical member 100B of the second embodiment includes the deformed fibers 22 covered with the resin portion 21, binding strength of the deformed fibers 22 with respect to the resin portion 21 is higher than that in the optical member of the first embodiment. In the protruding portion 26, the leg portions 222 of the deformed fiber 22 is desirably covered with the resin portion 21. The number of leg portions 222 covered with the resin portion 21 may be one, or a plurality of leg portions 222 may be covered with the resin portion 21.

As described above, in the optical member 100B of the second embodiment, the protruding portion 26 including the deformed fiber 22 covered with the resin portion 21 is provided above the protrusion portion 12 of the base material 1. Thus, the optical member 100B is superior to the optical member 100 of the first embodiment in adhesion strength of the deformed fibers 22 with respect to the resin portion 21. Accordingly, because the optical member 100B of the second embodiment is superior in durability to the optical member 100 of the first embodiment, it is possible to reduce an amount of stray light generated in an optical system, for a longer period.

### (Antireflection Paint)

A third embodiment will be described. An antireflection paint to be used to form an antireflection film included in an optical member of the present disclosure contains the plurality of deformed fibers 22, resin, and an organic solvent. Because the deformed fibers 22 are the same as those used in the first and second embodiments, the description will be omitted.

A content of the deformed fibers 22 contained in the antireflection paint desirably falls within a range from 50 parts by mass to 200 parts by mass, with respect to 100 parts by mass of a paint solid content obtained before the deformed fibers 22 are mixed. The paint solid content refers to a content of all solid components contained in the antireflection paint that also include an additive agent in addition to resin included in the resin portion 21. If the content of the deformed fibers 22 is smaller than 50 parts by mass, there is concern that an antireflection function cannot be sufficiently obtained. On the other hand, if the content of the deformed fibers 22 is larger than 200 parts by mass, when the paint is applied using a spray gun, there is concern that a spray nozzle leading end is easily clogged, and a range of options of manufacturing methods is narrowed. Even if the antireflection film can be formed, because an amount of the paint solid content such as a content of resin is small, binding between the resin portion 21 and the deformed fibers 22 becomes insufficient, and there is concern that the deformed fibers 22 easily fall off. If the deformed fibers 22 are also regarded as a part of a solid content, it can be rephrased that the content of the deformed fibers 22 desirably falls within a range from 33 parts by mass to 67 parts by mass, with respect to the paint solid content of 100 parts by mass.

The resin contained in the antireflection paint of the present disclosure forms the resin portion 21 after the antireflection paint is dried. The type of resin is not specifically limited. For example, resin can be selected from acrylic resin, urethane resin, epoxy resin, and a combination of these. In addition, either solvent soluble resin or reactive curable resin may be used.

The content of the resin contained in the antireflection paint of the present disclosure desirably falls within a range from 5 parts by mass to 50 parts by mass, with respect to 100 parts by mass of the antireflection paint. If the content of the resin becomes smaller than 5 parts by mass, there is concern that adhesiveness between the resin portion 21 and the base material 1 worsens. On the other hand, if the content of the resin exceeds 50 parts by mass, there is concern that it becomes difficult to form a thin layer as the antireflection film 2.

The type of an organic solvent contained in the antireflection paint of the present disclosure is not specifically limited. Examples of the organic solvent include water, thinner, ethanol, isopropyl alcohol, n-butyl alcohol, ethyl acetate, propyl acetate, isobutyl acetate, and butyl acetate. Examples also include methyl ethyl ketone, methyl isobutyl ketone, propylene glycol monomethyl ether, toluene, xylene, acetone, cellosolves, glycol ethers, and ethers. One type of these solvents may be used, or a plurality of types may be mixed and used.

A content of an organic solvent contained in the antireflection paint of the present disclosure desirably falls within a range from 5 parts by mass to 80 parts by mass, with respect to 100 parts by mass of the antireflection paint. If the content of the organic solvent becomes smaller than 5 parts by mass, there is concern that it becomes difficult to form a thin layer as the antireflection film 2. In addition, when the paint is applied using a spray gun, there is concern that an ejection portion of the spray gun is clogged, and a range of options of manufacturing methods is narrowed. On the other hand, if the content of the organic solvent exceeds 80 parts by mass, there is concern that adhesiveness between the base material 1 and the resin portion 21 worsens. In addition, when the paint is applied using a spray gun, there is concern that dripping occurs.

A viscosity of the antireflection paint desirably falls within a range from 10 mPa·s to 200 mPa·s. If the viscosity of the antireflection paint becomes smaller than 10 mPa·s, there is concern that adhesiveness between the base material 1 and the antireflection film 2 worsens. On the other hand, if the viscosity of the antireflection paint becomes larger than 200 mPa·s, there is concern that it becomes difficult to form a thin layer as the antireflection film 2.

The antireflection paint of the present disclosure may further contain an additive agent. Examples of the additive agent include a dispersant, a hardener, a hardening catalyst, a plasticizer, a thixotropy imparting agent, a leveling agent, an infrared-transparent organic colorant, an infrared-transparent inorganic colorant, a preservative agent, an ultraviolet absorber, an antioxidant, and a coupling agent. In addition, a filler intended for coloring or frosting may be mixed.

In the antireflection paint of the present disclosure, it is possible to perform coating processing on the surfaces of the deformed fibers 22 for the purpose of enhancing dispersibility of the deformed fibers 22. In the coating processing, a surface-active agent, mineral salt, and various resins can be used.

An example of surface processing will be described. By processing the surface of the deformed fiber 22 cut into a desired length, using a tannin compound and a tartar emetic, the tannin compound is generated on a fiber surface. The electric conductivity on a flock surface is thereby kept in a good state by utilizing water retentivity of the tannin compound. Alternatively, inorganic salt, an inorganic silicon compound, a surfactant, and a mixture of these are bonded to the surface of the deformed fiber 22.

Examples of the tannin compound include natural tannin and synthetic tannin. Examples of the inorganic salt include a sodium chloride (NaCl), a barium chloride (BaCl₂), and a magnesium chloride (MgCl₂). The examples further include a magnesium sulphate (MgSO₄), a sodium silicate (Na₂SiO₃), a sodium carbonate (Na₂CO₃), and a sodium sulphate (Na₂SO₄). Examples of the inorganic silicon compound include colloidal silica. Furthermore, examples of the surfactant include an anionic surfactant, a non-ionic surfactant, an amphoteric surfactant, and a cationic surfactant.

### (Manufacturing Method of Antireflection Paint)

A manufacturing method of the antireflection paint of the present disclosure is not specifically limited, and it is sufficient that the deformed fibers 22 can be dispersed in the antireflection paint. The deformed fibers 22 may be injected into a container storing an organic solvent, or an organic solvent may be injected into a container storing the deformed fibers 22. Examples of a dispersing method include a bead mill, a ball mill, a jet mill, a three-roller mill, a planetary gear device, a mixer, and an ultrasonic disperser.

### (Optical Member)

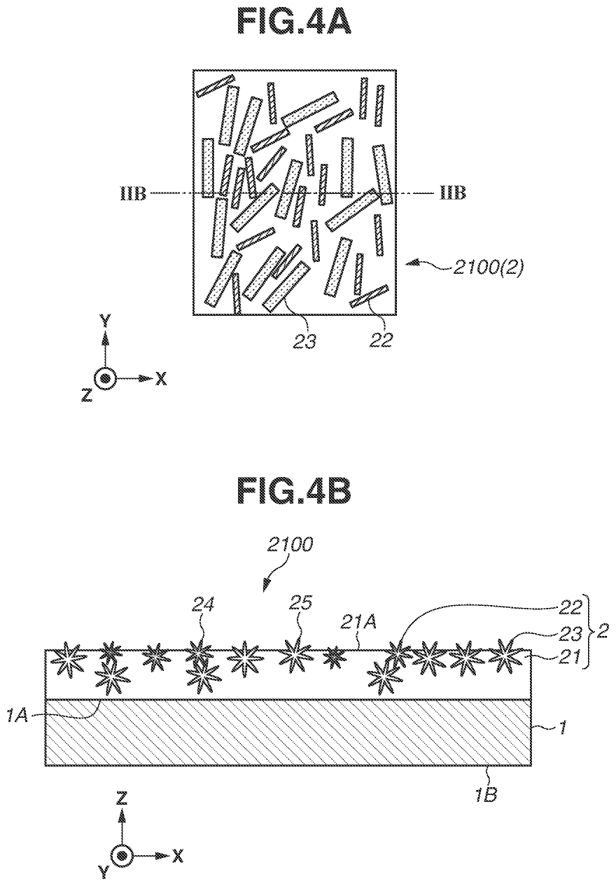

FIGS. 4A and 4B are schematic diagrams illustrating an embodiment of an optical member according to a fourth embodiment. FIG. 4A is a plan view and FIG. 4B is a cross-sectional view of an optical member 2100 that is taken along an IIB-IIB line in FIG. 4A. The optical member 2100 according to the fourth embodiment differs in that the antireflection film 2 includes a second fiber in addition to a deformed fiber (first deformed fiber) 22. Hereinafter, components equivalent to those in the first embodiment will be described using the same reference numerals.

The optical member 2100 includes a base material 1 and an antireflection film 2.

The antireflection film 2 includes a resin portion 21, the first deformed fiber 22, and the second fiber longer than the first deformed fiber 22. The antireflection film 2 is provided on a first surface 1A being a front surface of the base material 1.

The resin portion 21 has a first surface 21A being a front surface of the resin portion 21, contains the first deformed fiber 22, and includes a first protruding portion 24 protruding from the first surface 21A of the resin portion 21. In the fourth embodiment, the first protruding portion 24 is formed by the first deformed fiber 22 protruding from the first surface 21A of the resin portion 21. The first surface 21A of the resin portion 21 refers to a surface of the resin portion 21 that is on the opposite side of a surface being in contact with the base material 1 (base material side). The type of resin included in the resin portion 21 is not specifically limited. For example, the type of resin can be selected from acrylic resin, urethane resin, epoxy resin, and a combination of these. In addition, either solvent soluble resin or reactive curable resin may be used. To enhance absorption efficiency of light rays, the resin portion 21 is desirably dyed black using black dyeing material. The type of black dyeing material is not specifically limited. Organic material such as dyeing ink, metal such as nickel, cobalt, or copper, or inorganic material such as carbon black can be selected. The black refers to color having light absorbability within the entire range of a light wavelength range from 380 nm to 780 nm. In addition, the resin portion 21 desirably has a degree of blackness equal to or larger than 0.7. The degree of blackness is indicated by a ratio of a maximum absorptance with respect to a minimum absorptance in the light wavelength range from 380 nm to 780 nm.

A thickness of the resin portion 21 is not specifically limited, but desirably falls within a range from 10 μm to 500 μm. If the thickness of the resin portion 21 falls within the range, it is possible to achieve both of a good antireflection function and peel resistance. If the thickness of the resin portion 21 becomes smaller than 10 μm, there is concern that the antireflection function fails to be obtained sufficiently. On the other hand, if the thickness of the resin portion 21 exceeds 500 μm, film thickness unevenness is easily generated. If the film thickness unevenness becomes larger, the antireflection film 2 becomes more likely to peel from the base material 1. More desirably, the thickness of the resin portion 21 falls within a range from 20 μm to 200 μm.

The first deformed fibers 22 are bound to the resin portion 21. It is desirable that at least one of the plurality of first deformed fibers 22 protrudes from the first surface 21A of the resin portion 21 at least partially. In the present disclosure, a deformed fiber refers to a fiber having a cross-sectional shape in a direction vertical to a length direction (fiber axis direction) that is other than a circle, an ellipse, and a convex polygon in which all inner angles are smaller than 180°. By the first deformed fiber 22 protruding from the first surface 21A of the resin portion 21, even if a light ray deviating from an optical path (for example, a light ray with a high incidence angle exceeding 80 degrees) enters the first surface 21A of the resin portion 21, the light ray becomes less likely to return to the optical path by impinging on the protruding first deformed fiber 22. Nevertheless, if deformed fibers included in an optical member have a fixed length, when an environmental temperature drastically changes, a crack or a chap has been sometimes generated in an antireflection film. In view of the foregoing, as a result of earnest consideration, the inventor of the subject application has discovered that, by causing an antireflection film to contain a second fiber longer than a first deformed fiber contained in the antireflection film, even if an environmental temperature drastically changes, a crack or a chap becomes less likely to be generated in the antireflection film. Although a mechanism is unclear, it is estimated that, by causing an antireflection film to contain appropriate quantities of fibers longer than conventionally-used deformed fibers, tensile stress in a resin portion that is generated when an environmental temperature drastically changes from a high temperature to a low temperature is reduced.

The second fiber has a longer length in a fiber axis direction than that of the first deformed fiber 22. The second fiber is bound to the resin portion 21, and has a function of reducing stress to be generated in the resin portion 21. The shape of the second fiber is not specifically limited as long as its length is longer than that of the first deformed fiber 22, and a cross-sectional shape in a direction vertical to the length direction (fiber axis direction) may be a circle, an ellipse, or a convex polygon in which all inner angles are smaller than 180°. Nevertheless, the second fiber is desirably a second deformed fiber 23. This is because, by at least one of a plurality of second deformed fibers 23 forming a second protruding portion 25 protruding from the first surface 21A of the resin portion 21 at least partially, even if a light ray deviating from an optical path enters the first surface 21A of the resin portion 21, the light ray becomes less likely to return to the optical path by impinging on the second protruding portion 25.

It is desirable that fiber axes of the first deformed fibers 22 and the second deformed fibers 23 are oriented not unidirectionally but multidirectionally on an XY-plane as illustrated in FIG. 4A. This is because, if the fiber axes are oriented unidirectionally, when an environmental temperature changes, there is concern that a crack or a chap is generated in a specific direction.

The following description will be given of an example in which the second deformed fiber 23 is used as the second fiber.

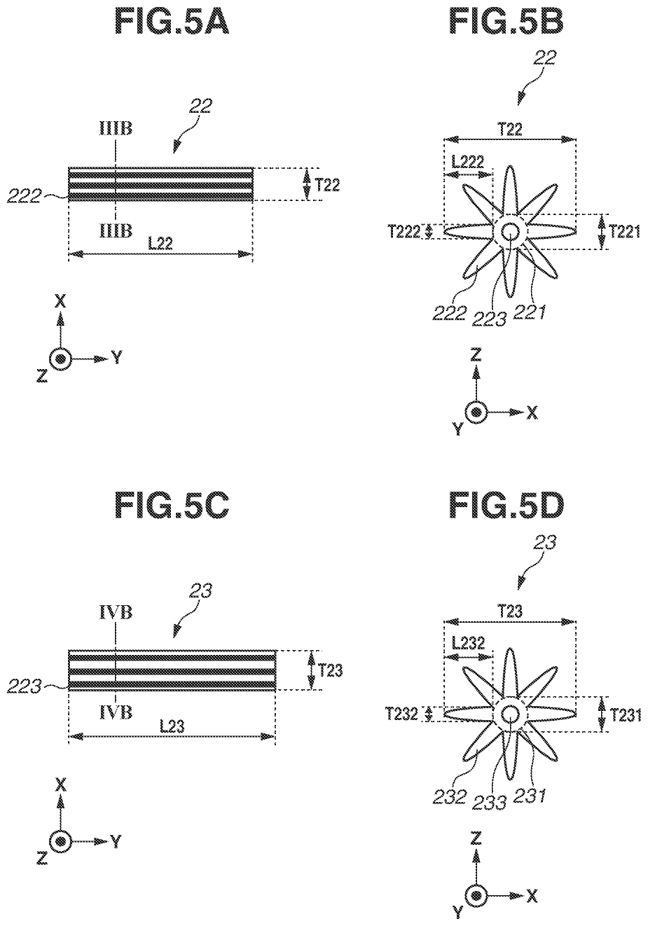

FIGS. 5A, 5B, 5C, and 5D are schematic diagrams of a deformed fiber usable in the optical member of the present embodiment. FIG. 5A is a plan view of the first deformed fiber 22 and FIG. 5B is a cross-sectional view of the first deformed fiber 22 that is taken along an line in FIG. 5A. FIG. 5C is a plan view of the second deformed fiber 23 and FIG. 5D is a cross-sectional view of the second deformed fiber 23 that is taken along an IVB-IVB line in FIG. 5C.

The first deformed fiber 22 plays a role in improving the antireflection function, by being included in the first protruding portion 24 protruding from the first surface 21A of the resin portion 21. From the aspect of further improvement in the antireflection function, a content of the first deformed fibers 22 in the antireflection film 2 is desirably larger than a content of the second deformed fibers 23. Similarly, the number of the first deformed fibers 22 in the antireflection film 2 is desirably larger than the number of the second deformed fibers 23. In addition, a total volume of the first deformed fibers 22 in the antireflection film 2 is desirably larger than a total volume of the second deformed fibers 23.

The first deformed fiber 22 includes a first core portion 221 and a plurality of first leg portions 222 extending from the first core portion 221. The first core portion 221 is a portion drawn by a dotted line in FIG. 5B, and its cross-sectional shape is a circular shape. Nevertheless, the cross-sectional shape of the first core portion 221 need not always be a circular shape, and may be a rectangular shape. In a case where the cross-sectional shape of the first core portion 221 is a circle, a thickness T221 of the first core portion 221 (length of a cross section in a direction vertical to a length direction of the first deformed fiber 22) indicates a diameter of the circle. In a case where the cross-sectional shape of the first core portion 221 is a polygon, the thickness T221 indicates a diameter of an inscribed circle of the polygon. In a case where the cross-sectional shape of the first core portion 221 is an ellipse, the thickness T221 indicates a diameter on a semimajor axis side. The first core portion 221 may include a first hole 223.

A length L22 of the first deformed fiber 22 desirably falls within a range from 0.2 mm to 1.0 mm. If the length L22 of the first deformed fiber 22 falls within the range, the antireflection function improves. If the length L22 of the first deformed fiber 22 is shorter than 0.2 mm, a higher proportion of a cut surface of the first deformed fiber 22 that does not include the antireflection function protrudes from the first surface 21A of the resin portion 21. Accordingly, there is concern that the antireflection function becomes insufficient. On the other hand, if the length L22 of the first deformed fiber 22 is longer than 1.0 mm, there is concern that it becomes difficult to cause the first leg portions 222 of the first deformed fiber 22 to protrude from the first surface 21A of the resin portion 21 when the antireflection film 2 is formed. The length L22 of the first deformed fiber 22 can be set to a desired length by cutting the first deformed fiber 22 using a cutting machine.

A thickness T22 of the first deformed fiber 22 desirably falls within a range from 10 μm to 50 μm. The thickness T22 of the first deformed fiber 22 refers to a length of a cross section in a direction vertical to a length direction of the first deformed fiber 22, and refers to a length of a cross section orthogonal to a fiber axis. In other words, the thickness T22 of the first deformed fiber 22 is a maximum value of a sum of lengths in a cross-section direction of the first core portion 221 and the first leg portions 222. If the thickness T22 of the first deformed fiber 22 falls within the range, it is possible to achieve both of the antireflection function and manufacturing easiness. If the thickness T22 of the first deformed fiber 22 is smaller than 10 μm, a portion protruding from the first surface 21A of the resin portion 21 becomes smaller. Accordingly, there is concern that the antireflection function becomes insufficient. On the other hand, if the thickness T22 of the first deformed fiber 22 is larger than 50 μm, there is concern that it takes time to execute a cutting process for adjusting a length.

A first aspect ratio being a ratio (L22/T22) of the length L22 of the first deformed fiber 22 with respect to the thickness T22 of the first deformed fiber 22 desirably falls within a range from 4 to 100. If the first aspect ratio falls within the range, it becomes easier to form the first protruding portion 24 by the leading end of the first leg portion 222 of the first deformed fiber 22 protruding from the first surface 21A of the resin portion 21 when the antireflection film 2 is formed. Nevertheless, if the first aspect ratio becomes smaller than 4 and the shape of the first deformed fiber 22 gets closer to an isotropic shape, a cut surface of the first deformed fiber 22 becomes more likely to protrude from the first surface 21A of the resin portion 21. Accordingly, there is concern that the antireflection function becomes insufficient. On the other hand, if the first aspect ratio becomes larger than 100, it becomes difficult to control the orientation of the first deformed fiber 22. Accordingly, there is concern that it becomes difficult for the leading end of the first leg portion 222 to protrude from the first surface 21A of the resin portion 21.

The first leg portions 222 extend from the first core portion 221, and are made of the same material as the first core portion 221. In FIG. 5B, the number of first leg portions 222 is eight, but the number of first leg portions 222 is not limited to eight. Among regions of the first deformed fiber 22, a region protruding from the first surface 21A of the resin portion 21 desirably corresponds to the first leg portions 222. This is because, by the plurality of first leg portions 222 protruding from the first surface 21A, light rays entering a space between two first leg portions can be caused to diffuse and made less likely to return to an optical path. To diffuse light rays more efficiently between first leg portions in the first deformed fiber 22, it is desirable that the number of first leg portions 222 is three or more and eight or less. As an example of a commercially available deformed fiber including eight first leg portions, there is Octa® manufactured by TEIJIN FRONTIER CO., LTD. It is difficult to manufacture a first deformed fiber including nine or more first leg portions.

A length L222 of the first leg portions 222 desirably falls within a range from 5 μm to 20 μm. If the length L222 of the first leg portions 222 falls within the range, a reflectance reduction effect becomes larger. If the length L222 of the first leg portions 222 is smaller than 5 μm, a length by which the first leg portion 222 protrudes from the first surface 21A of the resin portion 21 (a length of the first protruding portion 24) becomes shorter, and light reflection between the plurality of first leg portions 222 does not occur sufficiently. Accordingly, there is concern that the reflectance reduction effect becomes insufficient. On the other hand, if the length L222 of the first leg portions 222 is larger than 20 the first leg portions 222 incline or collapse, and a sufficient amount of light rays cannot enter a space between the plurality of first leg portions 222. Accordingly, there is concern that the reflectance reduction effect becomes insufficient. More desirably, the length L222 of the first leg portions 222 falls within a range from 5 μm to 12.5 μm.

A thickness T222 of the first leg portions 222 desirably falls within a range from 2 μm to 6 μm. If the thickness T222 of the first leg portions 222 falls within the range, a reflectance reduction effect becomes larger. If the thickness T222 of the first leg portions 222 is smaller than 2 the first leg portions 222 incline or collapse, and a sufficient amount of light cannot enter a space between the plurality of first leg portions 222. Accordingly, there is concern that the reflectance reduction effect becomes insufficient. On the other hand, if the thickness T222 of the first leg portions 222 is larger than 6 μm, an interval between the plurality of first leg portions 222 becomes smaller, and light reflection between the plurality of first leg portions 222 does not occur sufficiently. Accordingly, there is concern that the reflectance reduction effect becomes insufficient.

The second deformed fiber 23 includes a second core portion 231 and a plurality of second leg portions 232 extending from the second core portion 231. The second core portion 231 is a portion drawn by a dotted line in FIG. 5D, and its cross-sectional shape is a circular shape. Nevertheless, similarly to the first core portion 221, the cross-sectional shape of the second core portion 231 need not always be a circular shape, and may be a rectangular shape. The second core portion 231 may include a second hole 233.

A length L23 of the second deformed fiber 23 is longer than the length L22 of the first deformed fiber 22. Because the length L23 of the second deformed fiber 23 is longer than the length L22 of the first deformed fiber 22, the second deformed fiber 23 plays a role in increasing the strength of the antireflection film 2. Nevertheless, from the aspect of improvement in the antireflection function, a content of the second deformed fibers 23 in the antireflection film 2 is desirably smaller than a content of the first deformed fibers 22. Similarly, the number of the second deformed fibers 23 in the antireflection film 2 is desirably smaller than the number of the first deformed fibers 22. In addition, a total volume of the second deformed fibers 23 in the antireflection film 2 is desirably smaller than a total volume of the first deformed fibers 22. In addition, similarly to the first deformed fiber 22, it is desirable that at least a part of the second deformed fiber 23 protrudes from the first surface 21A of the resin portion 21, and forms the second protruding portion 25. At this time, the second deformed fiber 23 also plays a role in improving the antireflection function similarly to the first deformed fiber 22.

The length L23 of the second deformed fiber 23 desirably falls within a range from 0.3 mm to 1.5 mm. If the length L23 of the second deformed fiber 23 falls within the range, the antireflection film 2 becomes less likely to crack, and the antireflection function improves. If the length L23 of the second deformed fiber 23 is shorter than 0.3 mm, there is concern that a reduction effect of tensile stress generated in the resin portion 21 when an environmental temperature drastically changes becomes insufficient. On the other hand, if the length L23 of the second deformed fiber 23 is longer than 1.5 mm, when the second deformed fiber 23 is caused to protrude from the first surface 21A of the resin portion 21, the second deformed fiber 23 inclines and overlaps the first deformed fiber 22. Accordingly, there is concern that the antireflection function fails to become sufficient. More desirably, the length L23 of the second deformed fiber 23 falls within a range from 1.5 times to 5 times, of the length L22 of the first deformed fiber 22.

A thickness T23 of the second deformed fiber 23 is desirably larger than the thickness T22 of the first deformed fiber 22. This is to increase a reduction effect of tensile stress generated in the resin portion 21 when an environmental temperature drastically changes. In addition, the thickness T23 of the second deformed fiber 23 desirably falls within a range from 15 μm to 75 μm. If the thickness T23 of the second deformed fiber 23 falls within the range, the antireflection film 2 becomes less likely to crack, and manufacturing easiness becomes good. If the thickness T23 of the second deformed fiber 23 is smaller than 15 μm, there is concern that a reduction effect of tensile stress generated in the resin portion 21 when an environmental temperature drastically changes becomes insufficient. On the other hand, if the thickness T23 of the second deformed fiber 23 is larger than 75 μm, there is concern that it takes time to execute a cutting process for adjusting a length. From the aspect of facilitation of manufacturing, the thickness T23 of the second deformed fiber 23 is desirably the same as the thickness T22 of the first deformed fiber 22. This is because the first deformed fiber 22 and the second deformed fiber 23 can be obtained only by cutting the same raw material into different lengths. The state in which the thickness T23 of the second deformed fiber 23 is the same as the thickness T22 of the first deformed fiber 22 refers to a state in which the thickness T23 of the second deformed fiber 23 falls within a range from 0.8 times to 1.2 times, of the thickness T22 of the first deformed fiber 22.

A second aspect ratio being a ratio (L23/T23) of the length L23 of the second deformed fiber 23 with respect to the thickness T23 of the second deformed fiber 23 desirably falls within a range from 4 to 100. If the second aspect ratio falls within the range, it becomes easier to form the second protruding portion 25 by the leading end of the second leg portion 232 of the second deformed fiber 23 protruding from the first surface 21A of the resin portion 21 when the antireflection film 2 is formed. Nevertheless, if the second aspect ratio becomes smaller than 4 and the shape of the second deformed fiber 23 gets closer to an isotropic shape, a cut surface of the second deformed fiber 23 becomes more likely to protrude from the first surface 21A of the resin portion 21. Accordingly, there is concern that the antireflection function becomes insufficient. On the other hand, if the second aspect ratio becomes larger than 100, it becomes difficult to control the orientation of the second deformed fiber 23. Accordingly, there is concern that it becomes difficult for the leading end of the second leg portion 232 to protrude from the first surface 21A of the resin portion 21.

The second leg portions 232 extend from the second core portion 231, and are made of the same material as the second core portion 231. In FIG. 5D, the number of second leg portions 232 is eight, but the number of second leg portions 232 is not limited to eight. Among regions of the second deformed fiber 23, a region protruding from the first surface 21A of the resin portion 21 desirably corresponds to the second leg portions 232. This is because, by the plurality of second leg portions 232 protruding from the first surface 21A, light rays entering a space between two second leg portions can be caused to diffuse and made less likely to return to an optical path. To diffuse light rays more efficiently between second leg portions in the second deformed fiber 23, it is desirable that the number of second leg portions 232 is three or more and eight or less.

A length L232 of the second leg portions 232 desirably falls within a range from 7.5 μm to 30 μm. If the length L232 of the second leg portions 232 falls within the range, a reflectance reduction effect becomes larger. If the length L232 of the second leg portions 232 is smaller than 7.5 μm, a length by which the second leg portion 232 protrudes from the first surface 21A of the resin portion 21 (a length of the second protruding portion 25) becomes shorter, and light reflection between the plurality of second leg portions 232 does not occur sufficiently. Accordingly, there is concern that the reflectance reduction effect becomes insufficient. On the other hand, if the length L232 of the second leg portions 232 is larger than 30 μm, the second leg portions 232 incline or collapse, and a sufficient amount of light rays cannot enter a space between the plurality of second leg portions 232. Accordingly, there is concern that the reflectance reduction effect becomes insufficient. More desirably, the length L232 of the second leg portions 232 falls within a range from 7.5 μm to 15 μm.

A thickness T232 of the second leg portions 232 desirably falls within a range from 3 μm to 9 μm. If the thickness T232 of the second leg portions 232 falls within the range, a reflectance reduction effect becomes larger. If the thickness T232 of the second leg portions 232 is smaller than 3 μm, the second leg portions 232 incline or collapse, and a sufficient amount of light cannot enter a space between the plurality of second leg portions 232. Accordingly, there is concern that the reflectance reduction effect becomes insufficient. On the other hand, if the thickness T232 of the second leg portions 232 is larger than 9 μm, an interval between the plurality of second leg portions 232 becomes smaller, and light reflection between the plurality of second leg portions 232 does not occur sufficiently. Accordingly, there is concern that the reflectance reduction effect becomes insufficient.

From the aspect of facilitation of manufacturing, it is desirable that the thickness T23 of the second deformed fiber 23 is the same as the thickness T22 of the first deformed fiber 22, the length L232 of the second leg portions 232 is the same as the length L222 of the first leg portions 222, the thickness T232 of the second leg portions 232 is the same as the thickness T222 of the first leg portions 222, and the thickness T231 of the second core portion 231 is the same as the thickness T221 of the first core portion 221. This is because the first deformed fiber 22 and the second deformed fiber 23 can be obtained only by cutting the same raw material into different lengths. The state in which the length L232 of the second leg portions 232 is the same as the length L222 of the first leg portions 222 refers to a state in which the length L232 of the second leg portions 232 falls within a range from 0.8 times to 1.2 times, of the length L222 of the first leg portions 222. The state in which the thickness T232 of the second leg portions 232 is the same as the thickness T222 of the first leg portions 222 refers to a state in which the thickness T232 of the second leg portions 232 falls within a range from 0.8 times to 1.2 times, of the thickness T222 of the first leg portions 222. The state in which the thickness T231 of the second core portion 231 is the same as the thickness T221 of the first core portion 221 refers to a state in which the thickness T231 of the second core portion 231 falls within a range from 0.8 times to 1.2 times, of the thickness T221 of the first core portion 221.

The materials of the first deformed fiber 22 and the second deformed fiber 23 are not specifically limited. For example, the materials can be selected from polyester, nylon, acrylic, polypropylene, rayon, polyethylene, polyurethane, cotton linen, knitted wool, and a combination of these. To enhance the performance of the antireflection film 2, processing, light resistance processing, softening processing, or fading resistance processing may be performed on the first deformed fiber 22 and the second deformed fiber 23. Nevertheless, the first deformed fiber 22 and the second deformed fiber 23 are desirably made of the same material. This is because the first deformed fiber 22 and the second deformed fiber 23 can be easily manufactured only by varying a length by which the same fiber material is cut, during a manufacturing process. Among the above-described materials, polyester is especially desirable. This is because polyester has a small linear expansion coefficient, and can reduce stress generated in the antireflection film 2. Thus, it is especially desirable that the second deformed fiber 23 is made of polyester.

A sum of contents of the first deformed fibers 22 and the second deformed fibers 23 in the antireflection film 2 desirably falls within a range from 33 parts by mass to 67 parts by mass. If the sum of the contents of the first deformed fibers 22 and the second deformed fibers 23 falls within the range, the antireflection film 2 can achieve both of optical performance and manufacturing easiness. If the sum of the contents of the first deformed fibers 22 and the second deformed fibers 23 is smaller than 33 parts by mass, the number of deformed fibers protruding from the first surface 21A of the resin portion 21 becomes smaller. Accordingly, there is concern that the reflectance reduction effect becomes insufficient. On the other hand, if the sum of the contents of the first deformed fibers 22 and the second deformed fibers 23 exceeds 67 parts by mass, when the antireflection film 2 is formed by spray painting, the leading end of a spray nozzle becomes highly likely to be clogged, and there is concern that manufacturing becomes difficult. From the aspect of assurance of the antireflection function, a content of the first deformed fibers 22 is desirably 1.5 times or more of a content of the second deformed fibers 23.

A method for providing the antireflection film 2 on the first surface 1A of the base material 1 is not specifically limited. Examples of the method include brush painting, spray painting, dip painting, and transfer. All of these methods are methods that use, as raw material, a paint containing uncured resin being a precursor of the resin portion 21, the first deformed fibers 22 and the second deformed fibers 23, and an arbitrary solvent. From the aspect of being an easy method, it is desirable to apply the above-described paint using spray painting among the above-described methods. In addition, a method for obtaining the antireflection film 2 by curing the paint is not specifically limited, either. The paint may be dried at room temperature (for example, 23° C.±2° C.), curing may be promoted by heat, or ultraviolet light may be emitted onto the paint.

As described above, according to the optical member 2100 of the fourth embodiment, because the antireflection film 2 contains not only the first deformed fibers 22 but also the second fibers longer than the first deformed fibers 22, it is possible to reduce tensile stress in the resin portion 21 that is generated when an environmental temperature drastically changes from a high temperature to a low temperature. It is therefore possible to provide an optical member including an antireflection film in which a crack or a chap is less likely to be generated even if an environmental temperature drastically changes. Because a crack or a chap is less likely to be generated in the antireflection film 2 of the optical member 2100, there is a low possibility that a deformed fiber falls off in a device or an apparatus. Accordingly, because the optical member 2100 can maintain a low reflectance even if an environmental temperature changes, the optical member 2100 can reduce the influence of stray light that is exerted on desired performance of a device, without increasing an amount of stray light generated in an optical system.

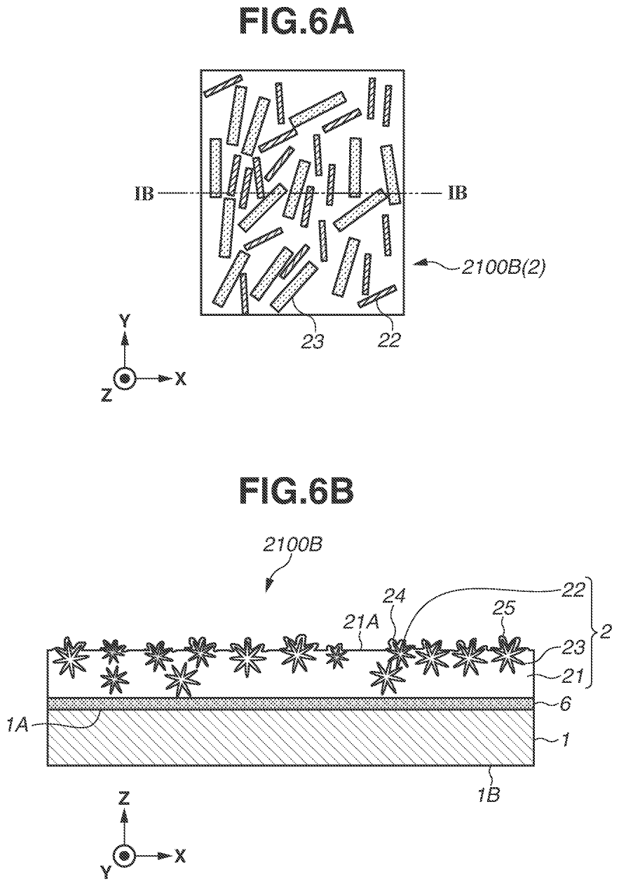

FIGS. 6A and 6B are schematic diagrams illustrating an embodiment of an optical member according to a fifth embodiment. FIG. 6A is a plan view and FIG. 6B is a cross-sectional view of an optical member 2100B that is taken along an IB-IB line in FIG. 6A. The optical member according to the fifth embodiment differs from that of the fourth embodiment in that an intermediate layer 6 is provided between the base material 1 and the antireflection film 2, the first deformed fiber 22 is covered with the resin portion 21 in the first protruding portion 24, and the second deformed fiber 23 is covered with the resin portion 21 in the second protruding portion 25. Hereinafter, the optical member of the fifth embodiment will be described mainly based on a point different from that of the fourth embodiment.

The intermediate layer 6 is a primer layer provided on the first surface 1A of the base material 1, for example, to enhance adhesiveness with the antireflection film 2. The material of the primer layer is not specifically limited. Examples of the material include epoxy resin, urethane resin, acrylic resin, silicone resin, and fluorine resin. The purpose of providing the intermediate layer 6 is not limited to the purpose of enhancing adhesiveness. The intermediate layer 6 may be provided for another purpose such as a purpose of preventing reaction between the first surface 1A of the base material 1 and a precursor of the antireflection film 2 in a manufacturing process. The thickness of the primer layer is not specifically limited.

The first deformed fiber 22 is covered with the resin portion 21 in the first protruding portion 24. Because the first deformed fiber 22 is covered with the resin portion 21 in the optical member 2100B of the fifth embodiment, binding strength of the first deformed fiber 22 with respect to the resin portion 21 is higher than that in the optical member 2100 of the fourth embodiment. The first leg portions 222 of the first deformed fiber 22 are desirably covered with the resin portion 21 in the first protruding portion 24. The number of first leg portions 222 covered with the resin portion 21 may be one, or a plurality of first leg portions 222 may be covered with the resin portion 21.

The second deformed fiber 23 is covered with the resin portion 21 in the second protruding portion 25. Because the second deformed fiber 23 is covered with the resin portion 21 in the optical member 2100B of the fifth embodiment, binding strength of the second deformed fiber 23 with respect to the resin portion 21 is higher than that in the optical member 2100 of the fourth embodiment. The second leg portions 232 of the second deformed fiber 23 are desirably covered with the resin portion 21 in the second protruding portion 25. The number of second leg portions 232 covered with the resin portion 21 may be one, or a plurality of second leg portions 232 may be covered with the resin portion 21.

As described above, the optical member 2100B of the fifth embodiment includes the first protruding portion 24 including the first deformed fiber 22 covered with the resin portion 21, and the second protruding portion 25 including the second deformed fiber 23 covered with the resin portion 21. Thus, the optical member 2100B is superior to the optical member 2100 of the fourth embodiment in adhesion strength of the first deformed fiber 22 and the second deformed fiber 23 with respect to the resin portion 21. Accordingly, because the optical member 2100B of the fifth embodiment is superior in durability to the optical member 2100 of the fourth embodiment, it is possible to reduce an amount of stray light generated in an optical system, for a longer period.

### (Antireflection Paint)

An antireflection paint to be used to form an antireflection film included in an optical member of the present disclosure contains the first deformed fibers 22, the second fibers, resin, and an organic solvent. Because the first deformed fibers 22 and the second fibers are the same as those used in the fourth and fifth embodiments, the description will be omitted.

A sum of contents of the first deformed fibers 22 and the second fibers contained in the antireflection paint desirably falls within a range from 50 parts by mass to 200 parts by mass, with respect to 100 parts by mass of a paint solid content obtained before the first deformed fibers 22 and the second fibers are mixed. The paint solid content refers to a content of all solid components contained in the antireflection paint that also include an additive agent in addition to resin included in the resin portion 21. If the sum of contents of the first deformed fibers 22 and the second fibers is smaller than 50 parts by mass, there is concern that the antireflection function cannot be sufficiently obtained. On the other hand, if the sum of contents of the first deformed fibers 22 and the second fibers is larger than 200 parts by mass, when the paint is applied using a spray gun, there is concern that a spray nozzle leading end is easily clogged, and a range of options of manufacturing methods is narrowed. Even if the antireflection film can be formed, because an amount of the paint solid content such as a content of resin is small, binding between the resin portion 21 and the first deformed fibers 22 and the second fibers becomes insufficient, and there is concern that the first deformed fibers 22 and the second fibers easily fall off. If the first deformed fibers 22 and the second fibers are regarded as a part of a solid content, it can be rephrased that the sum of contents of the first deformed fibers 22 and the second fibers desirably falls within a range from 33 parts by mass to 67 parts by mass, with respect to 100 parts by mass of the paint solid content.

The resin contained in the antireflection paint of the present disclosure forms the resin portion 21 after the antireflection paint is dried. The type of resin is not specifically limited. For example, resin can be selected from acrylic resin, urethane resin, epoxy resin, and a combination of these. In addition, either solvent soluble resin or reactive curable resin may be used.

The content of the resin contained in the antireflection paint of the present disclosure desirably falls within a range from 5 parts by mass to 50 parts by mass, with respect to 100 parts by mass of the antireflection paint. If the content of the resin becomes smaller than 5 parts by mass, there is concern that adhesiveness between the resin portion 21 and the base material 1 worsens. On the other hand, if the content of the resin exceeds 50 parts by mass, there is concern that it becomes difficult to form a thin layer as the antireflection film 2.

The type of an organic solvent contained in the antireflection paint of the present disclosure is not specifically limited. Examples of the organic solvent include water, thinner, ethanol, isopropyl alcohol, n-butyl alcohol, ethyl acetate, propyl acetate, isobutyl acetate, and butyl acetate. Examples also include methyl ethyl ketone, methyl isobutyl ketone, propylene glycol monomethyl ether, toluene, xylene, acetone, cellosolves, glycol ethers, and ethers. One type of these solvents may be used, or a plurality of types may be mixed and used.

A content of an organic solvent contained in the antireflection paint of the present disclosure desirably falls within a range from 5 parts by mass to 80 parts by mass, with respect to 100 parts by mass of the antireflection paint. If the content of the organic solvent becomes smaller than 5 parts by mass, there is concern that it becomes difficult to form a thin layer as the antireflection film 2. In addition, when the paint is applied using a spray gun, there is concern that an ejection portion of the spray gun is clogged, and a range of options of manufacturing methods is narrowed. On the other hand, if the content of the organic solvent exceeds 80 parts by mass, there is concern that adhesiveness between the base material 1 and the resin portion 21 worsens. In addition, when the paint is applied using a spray gun, there is concern that dripping occurs.

A viscosity of the antireflection paint desirably falls within a range from 10 mPa·s to 200 mPa·s. If the viscosity of the antireflection paint becomes smaller than 10 mPa·s, there is concern that adhesiveness between the base material 1 and the antireflection film 2 worsens. On the other hand, if the viscosity of the antireflection paint becomes larger than 200 mPa·s, there is concern that it becomes difficult to form a thin layer as the antireflection film 2.

The antireflection paint of the present disclosure may further contain an additive agent. Examples of the additive agent include a dispersant, a hardener, a hardening catalyst, a plasticizer, a thixotropy imparting agent, a leveling agent, an infrared-transparent organic colorant, an infrared-transparent inorganic colorant, a preservative agent, an ultraviolet absorber, an antioxidant, and a coupling agent. In addition, a filler intended for coloring or frosting may be mixed.

In the antireflection paint of the present disclosure, it is possible to perform coating processing on the surfaces of the first deformed fibers 22 and the second fibers for the purpose of enhancing dispersibility of the first deformed fibers 22 and the second fibers. In the coating processing, a surface-active agent, mineral salt, and various resins can be used.

An example of surface processing will be described. By processing the surfaces of the first deformed fiber 22 and the second fiber cut into desired lengths, using a tannin compound and a tartar emetic, the tannin compound is generated on a fiber surface. The electric conductivity on a flock surface is thereby kept in a good state by utilizing water retentivity of the tannin compound. Alternatively, inorganic salt, an inorganic silicon compound, a surfactant, and a mixture of these are bonded to the surfaces of the first deformed fiber 22 and the second fiber.

Examples of the tannin compound include natural tannin and synthetic tannin. Examples of the inorganic salt include a sodium chloride (NaCl), a barium chloride (BaCl₂), and a magnesium chloride (MgCl₂). The examples further include a magnesium sulphate (MgSO₄), a sodium silicate (Na₂SiO₃), a sodium carbonate (Na₂CO₃), and a sodium sulphate (Na₂SO₄). Examples of the inorganic silicon compound include colloidal silica. Furthermore, examples of the surfactant include an anionic surfactant, a non-ionic surfactant, an amphoteric surfactant, and a cationic surfactant.

### (Manufacturing Method of Antireflection Paint)

A manufacturing method of the antireflection paint of the present disclosure is not specifically limited, and it is sufficient that the first deformed fibers 22 and the second fibers can be dispersed in the antireflection paint. The first deformed fibers 22 and the second fibers may be injected into a container storing an organic solvent, or an organic solvent may be injected into a container storing the first deformed fibers 22 and the second fibers. Examples of a dispersing method include a bead mill, a ball mill, a jet mill, a three-roller mill, a planetary gear device, a mixer, and an ultrasonic disperser.

### (Optical Device and Imaging Apparatus)

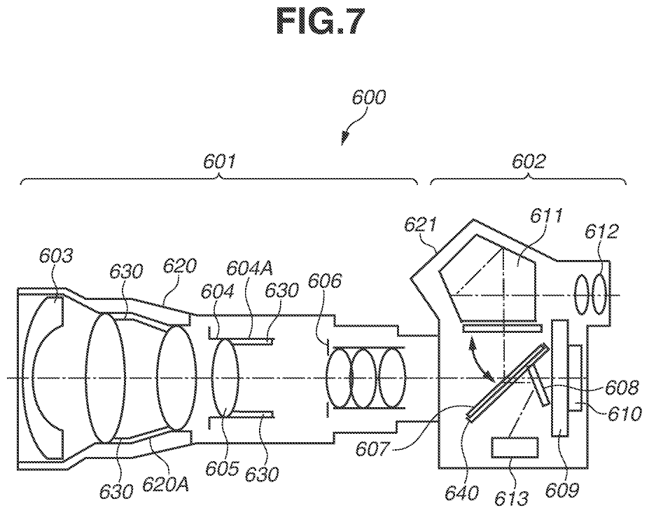

FIG. 7 is a schematic diagram illustrating an embodiment of a configuration of a single-lens reflex digital camera 600 serving as an example of an imaging apparatus, which includes a lens barrel serving as an example of an optical device according to a seventh embodiment. In FIG. 7, a camera main body 602 and a lens barrel 601 being an optical device are coupled, but the lens barrel 601 is a so-called interchangeable lens detachably attached to the camera main body 602.

Light from a subject is received by an image sensor 610 through an optical system including a plurality of lenses 603 and 605 serving as an example of a component arranged on an optical axis of an imaging optical system provided inside a casing 620 of the lens barrel 601, whereby an image is captured. The lens 605 is supported by an internal cylinder 604, and supported in such a manner as to be movable with respect to an external cylinder of the lens barrel 601 for focusing or zooming. The internal cylinder 604 is a supporting member that supports the lens 605.

In an observation period before image capturing, light from a subject is reflected by a main mirror 607 serving as an example of a component provided inside a casing 621 of the camera main body 602, and passes through a prism 611, and then, a captured image is shown to a photographer via a viewfinder lens 612. The main mirror 607 is a half mirror, for example. Light transmitted through the main mirror 607 is reflected by a sub mirror 608 toward a direction of an autofocus (AF) unit 613. The reflected light is used for distance measurement, for example. The main mirror 607 is attached to a main mirror holder 640 by adhesive bonding, and supported thereon. At the time of image capturing, the main mirror 607 and the sub mirror 608 are moved to deviate from an optical path, via a drive mechanism (not illustrated), a shutter 609 is opened, and a captured optical image of incident light from the lens barrel 601 is formed on the image sensor 610. A diaphragm 606 is configured to be able to change brightness and a focal depth in image capturing by changing an aperture area.

To apply the optical member of the first embodiment, the second embodiment, the fourth embodiment, or the fifth embodiment to the optical device of the seventh embodiment, the casing 620 has the same configuration as the base material 1, and an antireflection film 630 having the same configuration as the antireflection film 2 is provided on an inner wall surface 620A of the casing 620. Alternatively, the internal cylinder 604 has the same configuration as the base material 1, and the antireflection film 630 having the same configuration as the antireflection film 2 is provided on a first surface 604A of the supporting member, which is a surface of the internal cylinder 604 that is on a side on which the internal cylinder 604 supports the lens 605. By employing such a configuration, among light rays entering an optical device, light rays not being used for imaging and not contributing to the formation of a subject image become less likely to return to an optical path by impinging on deformed fibers. Consequently, an amount of stray lights reaching the image sensor 610 is reduced. According to the imaging apparatus of the seventh embodiment, because an amount of stray lights reaching the image sensor 610 is reduced, it is possible to provide an imaging apparatus that is less likely to generate flare or ghost, and superior in quality of a captured image.

In a case where a part of the inner wall surface 620A of the casing 620 and/or the first surface 604A is fixed with another member using a screw, the screw may serve as the protrusion portion 12.

The single-lens reflex digital camera has been described as an example of an imaging apparatus, but the present disclosure is not limited to this, and a smartphone or a compact digital camera may be used.

### (Display Apparatus)

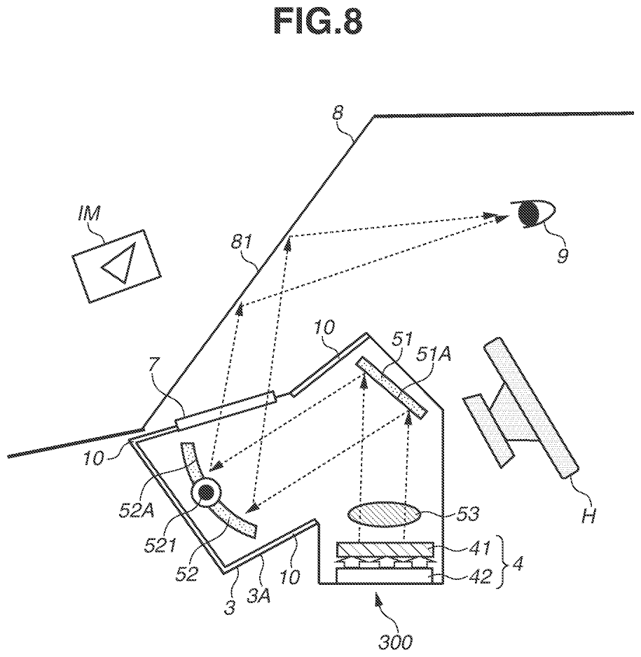

FIG. 8 is a schematic diagram illustrating an embodiment of a configuration of a head-up display 300 serving as an example of a display apparatus according to an eighth embodiment.

The head-up display 300 is installed on a vehicle such as an automobile, and displays a virtual image IM visible to a viewer being a driver having an eye 9, by projecting video light onto a windshield 8 serving as an example of a display unit. The head-up display 300 includes a casing 3, a video generation unit 4, and reflecting mirrors 51 and 52. The head-up display 300 is installed inside a dashboard provided in front of a steering wheel H, for example.

The video generation unit 4 is provided inside the casing 3. The video generation unit 4 includes a light source 42 and a display panel 41. The light source 42 is a device that emits light, and corresponds to a plurality of light-emitting diodes (LEDs), for example. The display panel 41 is a device that generates video light by modulating light emitted from the light source 42, and is a self-luminous display such as a transmissive liquid crystal display or an organic electroluminescence (EL) display, for example.

The reflecting mirrors 51 and 52 are provided inside the casing 3. The reflecting mirrors 51 and 52 respectively include reflection surfaces 51A and 52A, and reflect video light generated by the video generation unit 4, on the respective reflection surfaces 51A and 52A. Before being reflected on the reflection surface 51A, the generated video light may pass through an optical path including a condenser lens 53, as necessary. The reflecting mirror 52 includes a drive mechanism 521 including a motor and a gear. By driving the drive mechanism 521 using a control apparatus (not illustrated), an angle of the reflection surface 52A can be adjusted. The reflecting mirrors 51 and 52 are concave mirrors. The reflecting mirrors 51 and 52 are mirrors each obtained by forming a metal film such as an aluminum film on a base material surface containing resin and having a free-form surface shape. The metal film can be formed by vapor deposition, for example. The video light reflected by the reflecting mirror 52 is projected in an enlarged manner toward the windshield 8 positioned on the outside of the casing 3, via a transparent plate 7.

The transparent plate 7 is an acrylic plate, for example.

To apply the optical member of the first embodiment, the second embodiment, the fourth embodiment, or the fifth embodiment to the display apparatus of the eighth embodiment, the casing 3 has the same configuration as the base material 1, and an antireflection film 10 having the same configuration as the antireflection film 2 is provided on an inner wall surface 3A of the casing 3. By employing such a configuration, light rays generated when a backlight of the head-up display 300 is lit or when outside light enters the head-up display 300, and light rays reflected inside the casing 3 and not contributing to the formation of video light become less likely to return to an optical path by impinging on deformed fibers. Consequently, an amount of stray light reaching a display region 81 of the windshield 8 is reduced. According to the display apparatus of the eighth embodiment, because an amount of stray light reaching the windshield 8 is reduced, it is possible to provide a display apparatus superior in quality of an image (virtual image) generated from video light. In a case where a part of the inner wall surface 3A of the casing 3 is fixed with another member using a screw, the screw may serve as the protrusion portion 12.

In the eighth embodiment, the description has been given of an case where the head-up display 300 is installed on an automobile, but the head-up display 300 can also be applied to another vehicle such as an electric train or an airplane. In addition, the head-up display 300 can also be used for another use application other than vehicles. In addition, the display apparatus of the eighth embodiment can also be applied to a display apparatus such as a projector or a smart glass that is to be used indoors or outdoors. In FIG. 8, the antireflection films 10 are provided at three points on the inner wall surface 3A of the casing 3, but the number of antireflection films 10 provided inside the casing 3, and the positions of the antireflection films 10 are not limited to those in this configuration. The two reflecting mirrors 51 and 52 are provided inside the casing 3, but the number of reflecting mirrors may be one depending on the design of an optical system.

### (Display Apparatus)

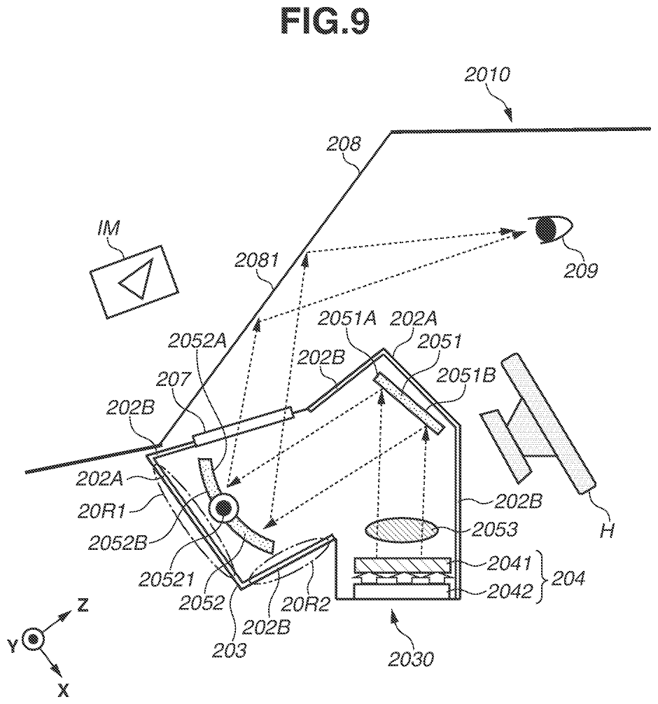

FIG. 9 is a schematic diagram illustrating an embodiment of a configuration of a head-up display 2030 mountable on a vehicle, which serves as an example of a display apparatus according to a ninth embodiment. In the following description, a Z-axis extends in a direction in which a first antireflection film 202A is stacked on a casing 203. In addition, a Y-axis extends in a sheet surface depth direction. In addition, a direction orthogonal to the Z-axis and the Y-axis is set as an X-axis. In an XYZ coordinate system including coordinate axes defined in this manner, a direction extending along the X-axis is referred to as an X direction, a direction extending along the Y-axis is referred to as a Y direction, and a direction extending along the Z-axis is referred to as a Z direction.

The head-up display 2030 is installed on a vehicle 2010 such as an automobile, and displays a virtual image IM visible to a viewer being a driver having an eye 209, by projecting video light onto a windshield 208 serving as an example of a display unit. The head-up display 2030 includes the casing 203, a video generation unit 204, a first reflecting mirror 2051, and a second reflecting mirror 2052. The head-up display 2030 is installed inside a dashboard provided in front of a steering wheel H, for example.

The video generation unit 204 is provided inside the casing 203. The video generation unit 204 includes a light source 2042 and a display panel 2041. The light source 2042 is a device that emits light, and corresponds to a plurality of LEDs, for example. The display panel 2041 is a device that generates video light by modulating light emitted from the light source 2042, and is a self-luminous display such as a transmissive liquid crystal display or an organic EL display, for example.

The first reflecting mirror 2051 and the second reflecting mirror 2052 are provided inside the casing 203.

The first reflecting mirror 2051 has a first reflection surface 2051A and a first surface 2051B provided on an opposite side of the first reflection surface 2051A. The first reflection surface 2051A has a function of reflecting video light generated by the video generation unit 204, toward the second reflecting mirror 2052. Before being reflected on the first reflection surface 2051A, video light generated by the video generation unit 204 may pass through an optical path including a condenser lens 2053, as necessary. The first reflecting mirror 2051 is a concave mirror. The first reflecting mirror 2051 is a mirror formed by providing a metal film such as an aluminum film on a base material surface containing resin and having a free-form surface shape, and the first reflection surface 2051A includes a metal film. The metal film can be formed by vapor deposition, for example.

The second reflecting mirror 2052 has a second reflection surface 2052A and a second surface 2052B provided on an opposite side of the second reflection surface 2052A. The second reflection surface 2052A has a function of projecting video light reflected by the first reflection surface 2051A of the first reflecting mirror 2051, in an enlarged manner toward the windshield 208 positioned on the outside of the casing 203. The second reflecting mirror 2052 is a concave mirror. The second reflecting mirror 2052 is a mirror formed by providing a metal film such as an aluminum film on a base material surface containing resin and having a free-form surface shape, and the second reflection surface 2052A includes a metal film. The metal film can be formed by vapor deposition, for example. The second reflecting mirror 2052 includes a drive mechanism 20521 including a motor and a gear. By driving the drive mechanism 20521 using a control apparatus (not illustrated), an angle of the second reflection surface 2052A can be adjusted.

The video light reflected by the second reflecting mirror 2052 is projected in an enlarged manner toward the windshield 208 via a transparent plate 207. The transparent plate 207 is an acrylic plate, for example. The transparent plate 207 has a function of letting video light through, and preventing foreign matters and grit and dust from entering the casing 203.

Meanwhile, in the apparatus discussed in Japanese Patent Application Laid-Open No. 2021-196580, the suppression of stray light has been insufficient. As a result of earnest consideration, the inventor of the subject application has discovered that stray light reflected on inner wall surfaces of the casing 203 that are positioned on the rear side of the first reflecting mirror 2051 and the second reflecting mirror 2052 affects the quality of images. The present disclosure therefore employs a configuration of providing an antireflection film containing deformed fibers, on an inner wall surface of the casing 203 that is positioned on the rear side of a reflection surface of at least either of the first reflecting mirror 2051 and the second reflecting mirror 2052.

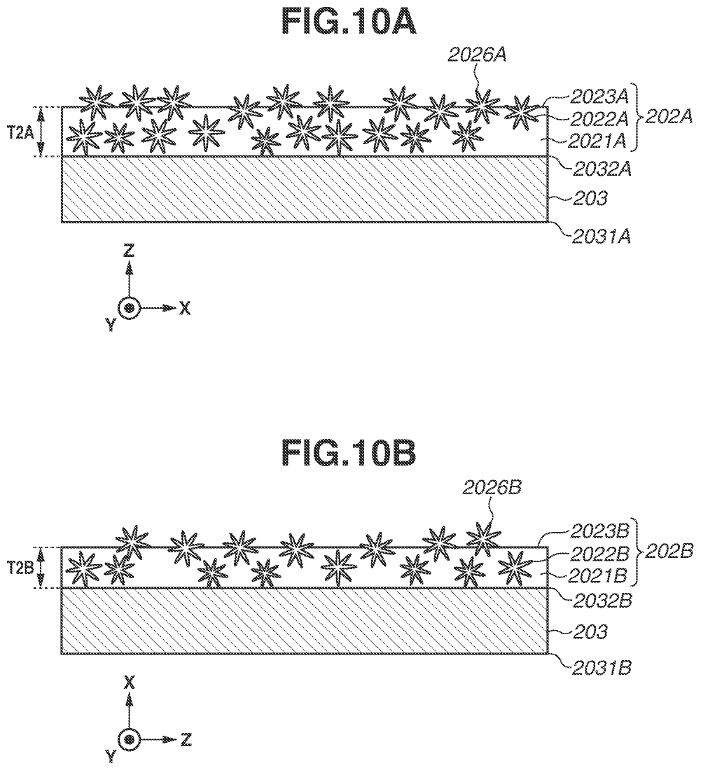

FIGS. 10A and 10B are schematic diagrams illustrating the casing 203 and antireflection films provided on inner wall surfaces of the casing 203. FIG. 10A is an enlarged view of a region 20R1 surrounded by a dashed-dotted line in FIG. 9, and FIG. 10B is an enlarged view of a region 20R2 surrounded by a dashed-two dotted line in FIG. 9.

First of all, the description will be given with reference to FIGS. 9 and 10A. A first inner wall surface 2032A of the casing 203 is a portion of an inner wall surface that faces the second surface 2052B of the second reflecting mirror 2052. The first antireflection film 202A is provided on the first inner wall surface 2032A of the casing 203 in close contact with the first inner wall surface 2032A. The casing 203 has a first outer wall surface 2031A being a surface on an opposite side of the first inner wall surface 2032A.

The material of the casing 203 is not specifically limited, and metal or resin can be used. Examples of metal include aluminum, aluminum alloy, titanium alloy, stainless, magnesium, and magnesium alloy. From the aspect of cost and durability, aluminum alloy or magnesium alloy is desirably used. Examples of resin include polycarbonate resin, acrylic resin, acrylonitrile butadiene styrene (ABS) resin, and fluorine resin.

The first antireflection film 202A includes a first resin portion 2021A and a first deformed fiber 2022A. The first antireflection film 202A is provided on the first inner wall surface 2032A of the casing 203.

The first resin portion 2021A has a first surface 2023A being a front surface of the first resin portion 2021A, contains the first deformed fiber 2022A, and includes a protruding portion 2026A protruding from the first surface 2023A of the first resin portion 2021A. In the ninth embodiment, the protruding portion 2026A is formed by the first deformed fiber 2022A protruding from the first surface 2023A of the first resin portion 2021A. The first surface 2023A of the first resin portion 2021A refers to a surface of the first resin portion 2021A that is on the opposite side of a surface being in contact with the first inner wall surface 2032A of the casing 203. The type of resin included in the first resin portion 2021A is not specifically limited. For example, the type of resin can be selected from acrylic resin, urethane resin, epoxy resin, and a combination of these. In addition, either solvent soluble resin or reactive curable resin may be used. To enhance absorption efficiency of light rays, the first resin portion 2021A is desirably dyed black using black dyeing material. The type of black dyeing material is not specifically limited. Organic material such as dyeing ink, metal such as nickel, cobalt, or copper, or inorganic material such as carbon black can be selected. The black refers to color having light absorbability within the entire range of a light wavelength range from 380 nm to 780 nm. In addition, the first resin portion 2021A desirably has a degree of blackness equal to or larger than 0.7. The degree of blackness is indicated by a ratio of a maximum absorptance with respect to a minimum absorptance in the light wavelength range from 380 nm to 780 nm.

A thickness of the first resin portion 2021A is not specifically limited, but desirably falls within a range from 10 μm to 500 μm. If the thickness of the first resin portion 2021A falls within the range, it is possible to achieve both of a good antireflection function and peel resistance. If the thickness of the first resin portion 2021A becomes smaller than 10 μm, there is concern that the antireflection function fails to be obtained sufficiently. On the other hand, if the thickness of the first resin portion 2021A exceeds 500 μm, film thickness unevenness is easily generated. If the film thickness unevenness becomes larger, the first antireflection film 202A becomes more likely to peel from the first inner wall surface 2032A of the casing 203. More desirably, the thickness of the first resin portion 2021A falls within a range from 20 μm to 200 μm.

The first deformed fibers 2022A are bound to the first resin portion 2021A. At least one of the plurality of first deformed fibers 2022A protrudes from the first surface 2023A of the first resin portion 2021A at least partially. In the present disclosure, a deformed fiber refers to a fiber having a cross-sectional shape in a direction vertical to a length direction (fiber axis direction) that is other than a circle, an ellipse, and a convex polygon in which all inner angles are smaller than 180°. By the first deformed fiber 2022A protruding from the first surface 2023A of the first resin portion 2021A, even if a light ray deviating from an optical path (for example, a light ray with a high incidence angle exceeding 80 degrees) enters the first surface 2023A of the first resin portion 2021A, the light ray becomes less likely to return to the optical path by impinging on the protruding first deformed fiber 2022A.

Subsequently, the description will be given with reference to FIGS. 9 and 10B. A second inner wall surface 2032B of the casing 203 refers to a portion of the inner wall surface that extends on the side of the second reflection surface 2052A of the second reflecting mirror 2052 with forming a predetermined angle with the first inner wall surface 2032A. In FIG. 9, an angle formed by the first inner wall surface 2032A and the second inner wall surface 2032B is about 100 degrees, and the second inner wall surface 2032B extends in a direction from the second surface 2052B toward the second reflection surface 2052A with forming an angle of about 10 degrees with the Z-axis. A second antireflection film 202B is provided on the second inner wall surface 2032B of the casing 203 in close contact with the second inner wall surface 2032B. The casing 203 has a second outer wall surface 2031B being a surface on an opposite side of the second inner wall surface 2032B. In the ninth embodiment, the first antireflection film 202A and the second antireflection film 202B are integrally formed continuously without being separated. Integrally forming the first antireflection film 202A and the second antireflection film 202B has an advantage in that the number of manufacturing processes can be reduced. Nevertheless, the first antireflection film 202A and the second antireflection film 202B need not be integrally formed.

The second antireflection film 202B includes a second resin portion 2021B and a second deformed fiber 2022B. The second antireflection film 202B is provided on the second inner wall surface 2032B of the casing 203.

It is desirable that the second resin portion 2021B has a first surface 2023B of the second resin portion 2021B, and includes a protruding portion 2026B formed by the second deformed fiber 2022B protruding from the first surface 2023B of the second resin portion 2021B. This is to improve the antireflection function of the second antireflection film 202B similarly to the first antireflection film 202A. The first surface 2023B of the second resin portion 2021B refers to a surface of the second resin portion 2021B that is on the opposite side of a surface being in contact with the second inner wall surface 2032B of the casing 203.

It is desirable that the second antireflection film 202B is formed using the same resin and the same deformed fibers as the first antireflection film 202A. Forming the second antireflection film 202B using the same resin and the same deformed fibers has an advantage in that the number of manufacturing processes can be reduced.

A thickness of the second resin portion 2021B is not specifically limited, but a thickness T2A of the first resin portion 2021A is desirably larger than a thickness T2B of the second resin portion 2021B. This is because an amount of light rays reflected on an inner wall of the casing 203 that is positioned on the rear side of the second reflecting mirror 2052 can be further reduced.

A content of the second deformed fibers 2022B in the second antireflection film 202B is not specifically limited, but a content of the first deformed fibers 2022A per unit area of the first antireflection film 202A is desirably larger than a content of the second deformed fibers 2022B per unit area of the second antireflection film 202B. This is because an amount of light rays reflected on an inner wall of the casing 203 that is positioned on the rear side of the second reflecting mirror 2052 can be further reduced.

A volume of the first deformed fibers 2022A protruding from the first surface 2023A of the first resin portion 2021A in the first antireflection film 202A is desirably larger than a volume of the second deformed fibers 2022B protruding from the first surface 2023B of the second resin portion 2021B in the second antireflection film 202B. This is because an amount of light rays reflected on an inner wall of the casing 203 that is positioned on the rear side of the second reflecting mirror 2052 can be further reduced.

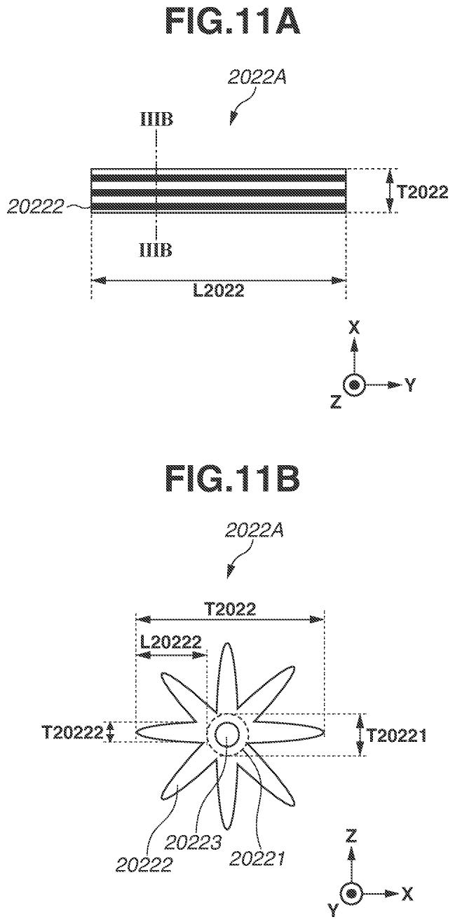

FIGS. 11A and 11B are schematic diagrams of a deformed fiber usable in the present embodiment. FIG. 11A is a plan view of the first deformed fiber 2022A and FIG. 11B is a cross-sectional view of the first deformed fiber 2022A that is taken along an IIIB-IIIB line in FIG. 11A. Because the same deformed fiber can be used as the first deformed fiber 2022A and the second deformed fiber 2022B, hereinafter, the first deformed fiber 2022A will be described as a representative.

The first deformed fiber 2022A includes a first core portion 20221 and a plurality of first leg portions 20222 extending from the first core portion 20221. The first core portion 20221 is a portion drawn by a dotted line in FIG. 11B, and its cross-sectional shape is a circular shape. Nevertheless, the cross-sectional shape of the first core portion 20221 need not always be a circular shape, and may be a rectangular shape. In a case where the cross-sectional shape of the first core portion 20221 is a circle, a thickness T20221 of the first core portion 20221 (length of a cross section in a direction vertical to a length direction of the first deformed fiber 2022A) indicates a diameter of the circle. In a case where the cross-sectional shape of the first core portion 20221 is a polygon, the thickness T20221 indicates a diameter of an inscribed circle of the polygon. In a case where the cross-sectional shape of the first core portion 20221 is an ellipse, the thickness T20221 indicates a diameter on a semimajor axis side. The first core portion 20221 may include a first hole 20223.

A length L2022 of the first deformed fiber 2022A desirably falls within a range from 0.2 mm to 1.0 mm. If the length L2022 of the first deformed fiber 2022A falls within the range, the antireflection function improves. If the length L2022 of the first deformed fiber 2022A is shorter than 0.2 mm, a higher proportion of a cut surface of the first deformed fiber 2022A that does not include the antireflection function protrudes from the first surface 2023A of the first resin portion 2021A. Accordingly, there is concern that the antireflection function becomes insufficient. On the other hand, if the length L2022 of the first deformed fiber 2022A is longer than 1.0 mm, there is concern that it becomes difficult to cause the first leg portions 20222 of the first deformed fiber 2022A to protrude from the first surface 2023A of the first resin portion 2021A when the first antireflection film 202A is formed. The length L2022 of the first deformed fiber 2022A can be set to a desired length by cutting the first deformed fiber 2022A using a cutting machine.

A thickness T2022 of the first deformed fiber 2022A desirably falls within a range from 10 μm to 50 μm. The thickness T2022 of the first deformed fiber 2022A refers to a length of a cross section in a direction vertical to a length direction of the first deformed fiber 2022A, and refers to a length of a cross section orthogonal to a fiber axis. In other words, the thickness T2022 of the first deformed fiber 2022A is a maximum value of a sum of lengths in a cross-section direction of the first core portion 20221 and the first leg portions 20222. If the thickness T2022 of the first deformed fiber 2022A falls within the range, it is possible to achieve both of the antireflection function and manufacturing easiness. If the thickness T2022 of the first deformed fiber 2022A is smaller than 10 μm, a portion protruding from the first surface 2023A of the first resin portion 2021A becomes smaller. Accordingly, there is concern that the antireflection function becomes insufficient. On the other hand, if the thickness T2022 of the first deformed fiber 2022A is larger than 50 there is concern that it takes time to execute a cutting process for adjusting a length.

A first aspect ratio being a ratio (L2022/T2022) of the length L2022 of the first deformed fiber 2022A with respect to the thickness T2022 of the first deformed fiber 2022A desirably falls within a range from 4 to 100. If the first aspect ratio falls within the range, it becomes easier to cause the leading end of the first leg portion 20222 of the first deformed fiber 2022A to protrude from the first surface 2023A of the first resin portion 2021A when the first antireflection film 202A is formed. Nevertheless, if the first aspect ratio becomes smaller than 4 and the shape of the first deformed fiber 2022A gets closer to an isotropic shape, a cut surface of the first deformed fiber 2022A becomes more likely to protrude from the first surface 2023A of the first resin portion 2021A. Accordingly, there is concern that the antireflection function becomes insufficient. On the other hand, if the first aspect ratio becomes larger than 100, it becomes difficult to control the orientation of the first deformed fiber 2022A. Accordingly, there is concern that it becomes difficult for the leading end of the first leg portion 20222 to protrude from the first surface 2023A of the first resin portion 2021A.

The first leg portions 20222 extend from the first core portion 20221, and are made of the same material as the first core portion 20221. In FIG. 11B, the number of first leg portions 20222 is eight, but the number of first leg portions 20222 is not limited to eight. Among regions of the first deformed fiber 2022A, the protruding portion 2026A protruding from the first surface 2023A of the first resin portion 2021A desirably corresponds to the first leg portions 20222. This is because, by the plurality of first leg portions 20222 protruding from the first surface 2023A, light rays entering a space between two first leg portions can be caused to diffuse and made less likely to return to an optical path. To diffuse light rays more efficiently between first leg portions in the first deformed fiber 2022A, it is desirable that the number of first leg portions 20222 is three or more and eight or less. As an example of a commercially available deformed fiber including eight first leg portions, there is Octa® manufactured by TEIJIN FRONTIER CO., LTD. It is difficult to manufacture a first deformed fiber including nine or more first leg portions.

A length L20222 of the first leg portions 20222 desirably falls within a range from 5 μm to 20 μm. If the length L20222 of the first leg portions 20222 falls within the range, a reflectance reduction effect becomes larger. If the length L20222 of the first leg portions 20222 is smaller than 5 μm, a length by which the first leg portion 20222 protrudes from the first surface 2023A of the first resin portion 2021A (a length of the protruding portion 2026A) becomes shorter, and light reflection between the plurality of first leg portions 20222 does not occur sufficiently. Accordingly, there is concern that the reflectance reduction effect becomes insufficient. On the other hand, if the length L20222 of the first leg portions 20222 is larger than 20 the first leg portions 20222 incline or collapse, and a sufficient amount of light rays cannot enter a space between the plurality of first leg portions 20222. Accordingly, there is concern that the reflectance reduction effect becomes insufficient. More desirably, the length L20222 of the first leg portions 20222 falls within a range from 5 μm to 12.5 μm.

A thickness T20222 of the first leg portions 20222 desirably falls within a range from 2 μm to 6 μm. If the thickness T20222 of the first leg portions 20222 falls within the range, a reflectance reduction effect becomes larger. If the thickness T20222 of the first leg portions 20222 is smaller than 2 μm, the first leg portions 20222 incline or collapse, and a sufficient amount of light cannot enter a space between the plurality of first leg portions 20222. Accordingly, there is concern that the reflectance reduction effect becomes insufficient. On the other hand, if the thickness T20222 of the first leg portions 20222 is larger than 6 μm, an interval between the plurality of first leg portions 20222 becomes smaller, and light reflection between the plurality of first leg portions 20222 does not occur sufficiently. Accordingly, there is concern that the reflectance reduction effect becomes insufficient.

A length of the second deformed fiber 2022B is desirably the same as the length L2022 of the first deformed fiber 2022A. At this time, the first deformed fiber 2022A and the second deformed fiber 2022B are desirably made of the same material. This is because the first deformed fiber 2022A and the second deformed fiber 2022B can be obtained only by cutting the same raw material. The state in which the length of the second deformed fiber 2022B is the same as the length L2022 of the first deformed fiber 2022A refers to a state in which the length of the second deformed fiber 2022B falls within a range from 0.8 times to 1.2 times, of the length L2022 of the first deformed fiber 2022A.

A thickness of the second deformed fiber 2022B is desirably the same as the thickness T2022 of the first deformed fiber 2022A. At this time, the first deformed fiber 2022A and the second deformed fiber 2022B are desirably made of the same material. In addition, a length of the second deformed fiber 2022B is desirably the same as the length L2022 of the first deformed fiber 2022A. This is because the first deformed fiber 2022A and the second deformed fiber 2022B can be obtained only by cutting the same raw material. The state in which the thickness of the second deformed fiber 2022B is the same as the thickness T2022 of the first deformed fiber 2022A refers to a state in which the thickness of the second deformed fiber 2022B falls within a range from 0.8 times to 1.2 times, of the thickness T2022 of the first deformed fiber 2022A.

The material of the first deformed fiber 2022A is not specifically limited. For example, the material can be selected from polyester, nylon, acrylic, polypropylene, rayon, polyethylene, polyurethane, cotton linen, knitted wool, and a combination of these. To enhance the performance of the first antireflection film 202A, processing, light resistance processing, softening processing, or fading resistance processing may be performed on the first deformed fiber 2022A. Nevertheless, the first deformed fiber 2022A and the second deformed fiber 2022B are desirably made of the same material. This is because the first deformed fiber 2022A and the second deformed fiber 2022B can be easily manufactured only by varying a length by which the same fiber material is cut, during a manufacturing process. Among the above-described materials, polyester is especially desirable. This is because polyester has a small linear expansion coefficient, and can reduce stress generated in the first antireflection film 202A.

A content of the first deformed fibers 2022A in the first antireflection film 202A desirably falls within a range from 33 parts by mass to 67 parts by mass. If the content of the first deformed fibers 2022A falls within the range, the first antireflection film 202A can achieve both of optical performance and manufacturing easiness. If the content of the first deformed fibers 2022A is smaller than 33 parts by mass, the number of the first deformed fibers 2022A protruding from the first surface 2023A of the first resin portion 2021A becomes smaller. Accordingly, there is concern that the reflectance reduction effect becomes insufficient. On the other hand, if the content of the first deformed fibers 2022A exceeds 67 parts by mass, when the first antireflection film 202A is formed by spray painting, the leading end of a spray nozzle becomes highly likely to be clogged, and there is concern that manufacturing becomes difficult.

A method for providing the first antireflection film 202A on the first inner wall surface 2032A of the casing 203 is not specifically limited. Examples of the method include brush painting, spray painting, dip painting, and transfer. All of these methods are methods that use, as raw material, a paint containing uncured resin being a precursor of the first resin portion 2021A, the first deformed fibers 2022A, and an arbitrary solvent. From the aspect of being an easy method, it is desirable to apply the above-described paint using spray painting among the above-described methods. In addition, a method for obtaining the first antireflection film 202A by curing the paint is not specifically limited, either. The paint may be dried at room temperature (for example, 23° C.±2° C.), curing may be promoted by heat, or ultraviolet light may be emitted onto the paint.

### Modified Example of Casing

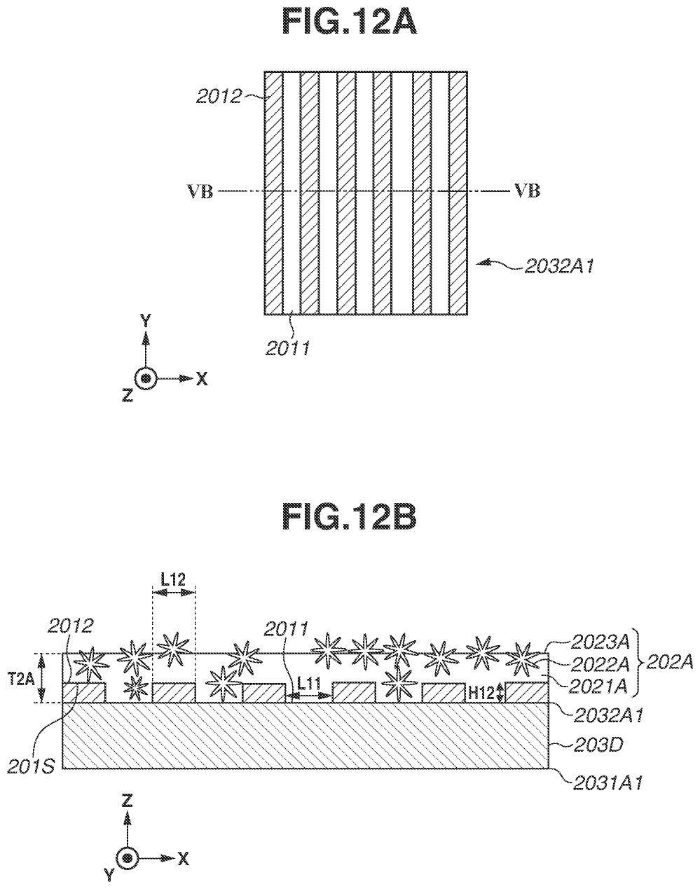

In the ninth embodiment, the first inner wall surface 2032A of the casing 203 is a planar surface, but an inner wall surface of a casing may have an irregular structure. FIGS. 12A and 12B are schematic diagrams illustrating an example in which a casing 3D of a modified example is used. FIG. 12A is a plan view and FIG. 12B is a cross-sectional view taken along a VB-VB line in FIG. 12A. For the sake of explanatory convenience, the illustration of the first antireflection film 202A is omitted in FIG. 12A.

A first inner wall surface 2032A1 of the casing 203D has an irregular structure. The irregular structure includes a plurality of protrusion portions 2012 and recess portions 2011. FIGS. 12A and 12B illustrate six protrusion portions 2012 and five recess portions 2011, but the number of protrusion portions 2012 and the number of recess portions 2011 are not limited to these numbers, and desired numbers can be appropriately selected.

At least one first deformed fiber 2022A is provided above at least one of the plurality of protrusion portions 2012. In other words, at least one first deformed fiber 2022A is provided in contact with the protrusion portion 2012. A height and a length of the protrusion portions 2012 are denoted by H12 and L12, respectively. The height H12 of the protrusion portions 2012 corresponds to a distance in the Z direction from a first reference 201S to the recess portion 2011. The first reference 201S refers to a position at which the protrusion portion 2012 and the first antireflection film 202A have contact with each other in the protrusion portion 2012 above which the first deformed fiber 2022A is provided. In FIG. 12B, the length L12 of the protrusion portions 2012 indicates a length in the X direction of the protrusion portions 2012, but may be a length in the Y direction. In other words, the length L12 of the protrusion portions 2012 indicates a length in a direction orthogonal to the Z direction being a height direction of the protrusion portions 2012, and indicates a smallest length of the protrusion portions 2012 that is set when the casing 203D is planarly viewed from the Z direction.

The recess portion 2011 is formed at a position at which the recess portion 2011 is recessed in a direction of getting farther away from the antireflection film 2, with respect to the first reference 201S. A length L2011 of the recess portions 2011 is a largest interval between two adjacent protrusion portions 2012.

A method for providing the irregular structure on the first inner wall surface 2032A1 is not specifically limited, but it is desirable that the irregular structure is formed by emboss processing. In other words, it is desirable that the first inner wall surface 2032A1 is an embossed surface formed by emboss processing. The emboss processing is processing of forming fine irregularities on the surface of a mold, when a molded component of metal or resin is obtained using a mold, and transferring the fine irregularities on the surface of the mold onto the surface of the molded component. The irregularities on the surface of the mold can be formed by chemical etching, sandblasting, or laser processing, for example. Because the emboss processing can form finer irregularities than those formed by mechanical processing, it becomes easier to cause the first deformed fiber 2022A to protrude from the first surface 2023A of the first resin portion 2021A, as compared with rough irregularities formed by mechanical processing. The type of grains formed by the emboss processing (configuration of the embossed surface) is not specifically limited. For example, leather texture, matt finish, wood texture, a textile pattern, or a geometric pattern can be used.

In a case where the casing 203D is fixed with another member using a screw, the screw may serve as the protrusion portion 2012.

As described above, according to the display apparatus of the ninth embodiment, stray light generated by being reflected or scattered on an inner wall surface positioned on the rear side of a reflecting mirror becomes less likely to return to an optical path by impinging on a deformed fiber. Consequently, an amount of stray light reaching a display region 2081 of the windshield 208 is reduced. According to the display apparatus of the ninth embodiment, because an amount of stray light reaching the windshield 208 is reduced, it is possible to provide a display apparatus superior in quality of an image (virtual image) generated from video light.

In the ninth embodiment, the description has been given of an case where the head-up display 2030 is installed on an automobile, but the head-up display 2030 can also be applied to another vehicle such as an electric train or an airplane. In addition, the head-up display 2030 can also be used for another use application other than vehicles. In addition, the display apparatus of the ninth embodiment can also be applied to a display apparatus such as a projector that is to be used indoors or outdoors. In FIG. 9, the antireflection films 202 are provided at two points on the inner wall surfaces of the casing 203, but the number of antireflection films 202 provided inside the casing 203, and the positions of the antireflection films 202 are not limited to those in this configuration. The two reflecting mirrors 2051 and 2052 are provided inside the casing 203, but the number of reflecting mirrors may be one depending on the design of an optical system.

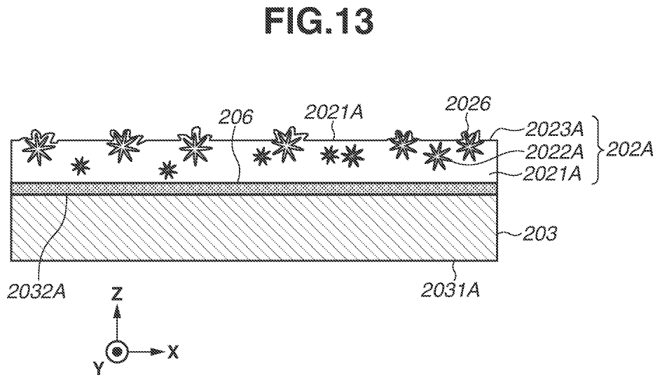

FIG. 13 is a schematic diagram illustrating an embodiment of a first antireflection film included in a display apparatus according to a tenth embodiment. The display apparatus according to the tenth embodiment differs from that of the ninth embodiment in that an intermediate layer 206 is provided between the casing 203 and the first antireflection film 202A, and the first deformed fiber 2022A is covered with the first resin portion 2021A in the protruding portion 2026. Hereinafter, an optical member of the tenth embodiment will be described mainly based on a point different from that of the ninth embodiment.

The intermediate layer 206 is a primer layer provided on the first inner wall surface 2032A of the casing 203, for example, to enhance adhesiveness with the first antireflection film 202A. The material of the primer layer is not specifically limited. Examples of the material include epoxy resin, urethane resin, acrylic resin, silicone resin, and fluorine resin. The purpose of providing the intermediate layer 206 is not limited to the purpose of enhancing adhesiveness. The intermediate layer 206 may be provided for another purpose such as a purpose of preventing reaction between the first inner wall surface 2032A of the casing 203 and a precursor of the first antireflection film 202A in a manufacturing process. The thickness of the primer layer is not specifically limited.

The first deformed fiber 2022A is covered with the first resin portion 2021A in the protruding portion 2026. Because the first deformed fiber 2022A is covered with the first resin portion 2021A in the tenth embodiment, binding strength of the first deformed fiber 2022A with respect to the first resin portion 2021A is higher than that in the ninth embodiment. First leg portions 20222A of the first deformed fiber 2022A are desirably covered with the first resin portion 2021A in the protruding portion 2026. The number of first leg portions 20222A covered with the first resin portion 2021A may be one, or a plurality of first leg portions 20222A may be covered with the first resin portion 2021A.

As described above, the display apparatus of the tenth embodiment includes the protruding portion 2026 including the first deformed fiber 2022A covered with the first resin portion 2021A. Thus, the display apparatus is superior to the display apparatus of the ninth embodiment in adhesion strength of the first deformed fiber 2022A with respect to the first resin portion 2021A. Accordingly, because the display apparatus of the tenth embodiment is superior in durability to the display apparatus of the ninth embodiment, it is possible to reduce an amount of stray light generated in an optical system, for a longer period.

### (Display Apparatus)

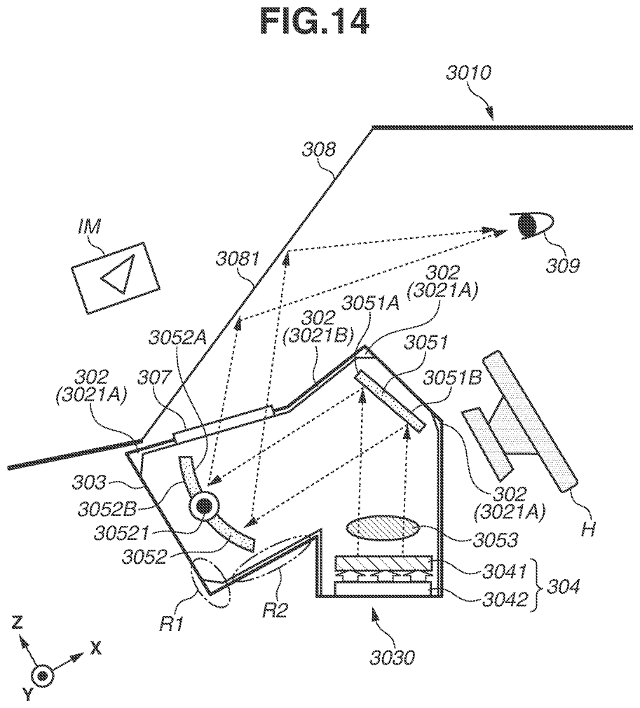

FIG. 14 is a schematic diagram illustrating an embodiment of a configuration of a head-up display 3030 mountable on a vehicle, which serves as an example of a display apparatus according to an eleventh embodiment. In the following description, a Z-axis extends in a direction in which an antireflection film 302 is stacked on a casing 303 in a region R2 to be described below. In addition, a Y-axis extends in a sheet surface depth direction. In addition, a direction orthogonal to the Z-axis and the Y-axis is set as an X-axis. In an XYZ coordinate system including coordinate axes defined in this manner, a direction extending along the X-axis is referred to as an X direction, a direction extending along the Y-axis is referred to as a Y direction, and a direction extending along the Z-axis is referred to as a Z direction.

The head-up display 3030 is installed on a vehicle 3010 such as an automobile, and displays a virtual image IM visible to a viewer being a driver having an eye 309, by projecting video light onto a windshield 308 serving as an example of a display unit. The head-up display 3030 includes the casing 303, a video generation unit 304, a first reflecting mirror 3051, and a second reflecting mirror 3052. The head-up display 3030 is installed inside a dashboard provided in front of a steering wheel H, for example.

The video generation unit 304 is provided on an inner side of an inner wall surface, which is an inside of the casing 303. The video generation unit 304 includes a light source 3042 and a display panel 3041. The light source 3042 is a device that emits light, and corresponds to a plurality of LEDs, for example. The display panel 3041 is a device that generates video light by modulating light emitted from the light source 3042, and is a self-luminous display such as a transmissive liquid crystal display or an organic EL display, for example.

The first reflecting mirror 3051 and the second reflecting mirror 3052 are provided an inner side of the inner wall surface, which is an inside of the casing 303.

The first reflecting mirror 3051 has a first reflection surface 3051A and a first surface 3051B provided on an opposite side of the first reflection surface 3051A. The first reflection surface 3051A has a function of reflecting video light generated by the video generation unit 304, toward the second reflecting mirror 3052. Before being reflected on the first reflection surface 3051A, video light generated by the video generation unit 304 may pass through an optical path including a condenser lens 3053, as necessary. The first reflecting mirror 3051 is a concave mirror. The first reflecting mirror 3051 is a mirror formed by providing a metal film such as an aluminum film on a base material surface containing resin and having a free-form surface shape, and the first reflection surface 3051A includes a metal film. The metal film can be formed by vapor deposition, for example.

The second reflecting mirror 3052 has a second reflection surface 3052A and a second surface 3052B provided on an opposite side of the second reflection surface 3052A. The second reflection surface 3052A has a function of projecting video light reflected by the first reflection surface 3051A of the first reflecting mirror 3051, in an enlarged manner toward the windshield 308 positioned on the outside of the casing 303. The second reflecting mirror 3052 is a concave mirror. The second reflecting mirror 3052 is a mirror formed by providing a metal film such as an aluminum film on a base material surface containing resin and having a free-form surface shape, and the second reflection surface 3052A includes a metal film. The metal film can be formed by vapor deposition, for example. The second reflecting mirror 3052 includes a drive mechanism 30521 including a motor and a gear. By driving the drive mechanism 30521 using a control apparatus (not illustrated), an angle of the second reflection surface 3052A can be adjusted.

The video light reflected by the second reflecting mirror 3052 is projected in an enlarged manner toward the windshield 308 via a transparent plate 307. The transparent plate 307 is an acrylic plate, for example. The transparent plate 307 has a function of letting video light through, and preventing foreign matters and grit and dust from entering the casing 303.

Meanwhile, in the apparatus discussed in Japanese Patent Application Laid-Open No. 2021-196580, the suppression of stray light has been insufficient. As a result of earnest consideration, the inventor of the subject application has discovered that stray light reflected at an intersection portion at which two inner wall surfaces of a casing intersect with each other, and a corner portion at which three inner wall surfaces of the casing intersect with each other affects the quality of images. The present disclosure therefore employs a configuration of providing an antireflection film containing deformed fibers, at the intersection portion and/or the corner portion more thickly than other portions among the inner wall surfaces of the casing.

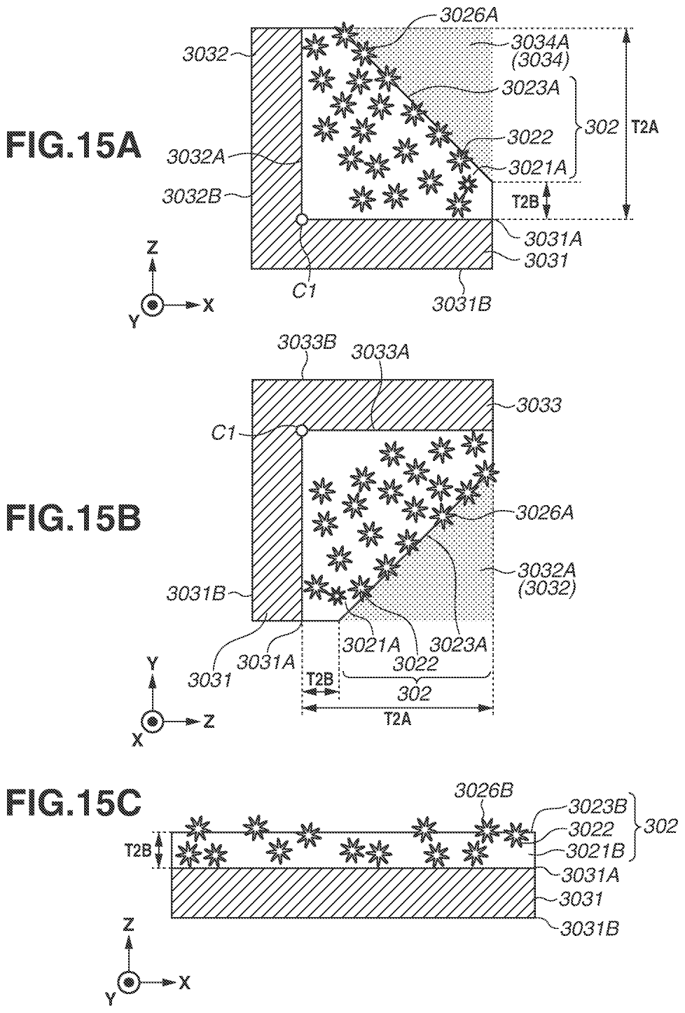

FIGS. 15A, 15B, and 15C are schematic diagrams illustrating a casing and an antireflection film provided on an inner wall surface of the casing. FIG. 15A is an enlarged view of a region R1 surrounded by a dashed-dotted line in FIG. 14, FIG. 15B is an enlarged view of the region R1 viewed from a position different from a view position in FIG. 15A, and a FIG. 15C is an enlarged view of a region R2 surrounded by a dashed-two dotted line in FIG. 14.

First of all, the description will be given with reference to FIGS. 14, 15A, and FIG. 15B. The casing 303 includes a first casing portion 3031, a second casing portion 3032, a third casing portion 3033, and a fourth casing portion 3034.

The first casing portion 3031 has a first inner wall surface 3031A and a first outer wall surface 3031B being a surface on an opposite side of the first inner wall surface 3031A. The first inner wall surface 3031A and the first outer wall surface 3031B extend on an XY-plane extending in the X direction and the Y direction. A thickness of the first casing portion 3031 corresponds to a distance in the Z direction between the first inner wall surface 3031A and the first outer wall surface 3031B.

The second casing portion 3032 has a second inner wall surface 3032A and a second outer wall surface 3032B being a surface on an opposite side of the second inner wall surface 3032A. The second inner wall surface 3032A and the second outer wall surface 3032B extend on a YZ-plane extending in the Y direction and the Z direction. A thickness of the second casing portion 3032 corresponds to a distance in the X direction between the second inner wall surface 3032A and the second outer wall surface 3032B. The second inner wall surface 3032A intersects with the first inner wall surface 3031A at a predetermined angle. The predetermined angle is an angle falling within a range from 0 degrees to 360 degrees, and except 0 degrees, 180 degrees, and 360 degrees. From the aspect of further enhancement in antireflection performance, a desirable predetermined angle falls within a range between 0 degrees and 180 degrees, both exclusive. The two inner wall surfaces (the first inner wall surface 3031A and the second inner wall surface 3032A) intersect with each other to form an intersection portion.

The third casing portion 3033 has a third inner wall surface 3033A and a third outer wall surface 3033B being a surface on an opposite side of the third inner wall surface 3033A. The third inner wall surface 3033A and the third outer wall surface 3033B extend on an XZ-plane extending in the X direction and the Z direction. A thickness of the third casing portion 3033 corresponds to a distance in the Y direction between the third inner wall surface 3033A and the third outer wall surface 3033B. The third inner wall surface 3033A intersects with the first inner wall surface 3031A and the second inner wall surface 3032A at a predetermined angle. The predetermined angle is an angle falling within a range from 0 degrees to 360 degrees, and except 0 degrees, 180 degrees, and 360 degrees. From the aspect of further enhancement in antireflection performance, a desirable predetermined angle falls within a range between 0 degrees and 180 degrees, both exclusive. The three inner wall surfaces (the first inner wall surface 3031A, the second inner wall surface 3032A, and the third inner wall surface 3033A) intersect with each other to form a corner portion Cl.

The fourth casing portion 3034 is a casing portion provided at a position facing the third casing portion 3033. A fourth inner wall surface 3034A and a fourth outer wall surface (not illustrated) extend on the XZ-plane extending in the X direction and the Z direction. The fourth inner wall surface 3034A intersects with the first inner wall surface 3031A and the second inner wall surface 3032A at a predetermined angle. The three inner wall surfaces (the first inner wall surface 3031A, the second inner wall surface 3032A, and the fourth inner wall surface 3034A) intersect with each other to form a corner portion (not illustrated).

The material of the casing 303 is not specifically limited, and metal or resin can be used. Examples of metal include aluminum, aluminum alloy, titanium alloy, stainless, magnesium, and magnesium alloy. From the aspect of cost and durability, aluminum alloy or magnesium alloy is desirably used. Examples of resin include polycarbonate resin, acrylic resin, ABS resin, and fluorine resin. To enhance adhesiveness with the antireflection film 302, a primer layer may be provided on the inner wall surface of the casing 303. The material of the primer layer is not specifically limited. Examples of the material include epoxy resin, urethane resin, acrylic resin, silicone resin, and fluorine resin.

The antireflection film 302 is provided in close contact with the inner wall surface of the casing 303. In FIG. 14, the antireflection films 302 are provided on the inner wall surfaces of the casing 303 except a portion facing the first surface 3051B of the reflecting mirror 3051 and a portion facing the second surface 3052B of the reflecting mirror 3052. Nevertheless, the antireflection film 302 may be provided in the portion facing the first surface 3051B of the reflecting mirror 3051 and the portion facing the second surface 3052B of the reflecting mirror 3052.

The antireflection film 302 includes a resin portion and deformed fibers 3022.

The resin portion includes a first resin portion 3021A having a first thickness T2A, and a second resin portion 3021B having a second thickness T2B. The first thickness T2A of the first resin portion 3021A is larger than the second thickness T2B of the second resin portion 3021B. In FIG. 15A, the antireflection film 302 is provided astride the first inner wall surface 3031A and the second inner wall surface 3032A. Thus, the first resin portion 3021A is provided above an intersection portion at which the first inner wall surface 3031A and the second inner wall surface 3032A intersect with each other. In FIG. 15B, the antireflection film 302 is provided astride the first inner wall surface 3031A and the third inner wall surface 3033A. Thus, the first resin portion 3021A is provided above an intersection portion at which the first inner wall surface 3031A and the third inner wall surface 3033A intersect with each other. As seen from FIGS. 15A and 15B, in the eleventh embodiment, the antireflection film 302 is provided astride the first inner wall surface 3031A, the second inner wall surface 3032A, and the third inner wall surface 3033A. Thus, the first resin portion 3021A is provided above the corner portion Cl at which the first inner wall surface 3031A, the second inner wall surface 3032A, and the third inner wall surface 3033A intersect with each other. Because the first resin portion 3021A larger than the second resin portion 3021B is provided at the above-described intersection portion and/or the corner portion, it is possible to reduce light rays reflected at the intersection portion and/or the corner portion inside the casing 303. In FIG. 14, the first resin portions 3021A are provided at four points, but the number of first resin portions 3021A is not limited to this.

The first resin portion 3021A has a first surface 3023A being a front surface of the first resin portion 3021A, contains the deformed fibers 3022, and includes a protruding portion 3026A protruding from the first surface 3023A of the first resin portion 3021A. In the eleventh embodiment, the protruding portion 3026A is formed by the deformed fiber 3022 protruding from the first surface 3023A of the first resin portion 3021A. The first surface 3023A of the first resin portion 3021A refers to a surface of the first resin portion 3021A that is on the opposite side of a surface being in contact with the inner wall surface of the casing 303. The type of resin included in the first resin portion 3021A is not specifically limited. For example, the type of resin can be selected from acrylic resin, urethane resin, epoxy resin, and a combination of these. In addition, either solvent soluble resin or reactive curable resin may be used. To enhance absorption efficiency of light rays, the first resin portion 3021A is desirably dyed black using black dyeing material. The type of black dyeing material is not specifically limited. Organic material such as dyeing ink, metal such as nickel, cobalt, or copper, or inorganic material such as carbon black can be selected. The black refers to color having light absorbability within the entire range of a light wavelength range from 380 nm to 780 nm. In addition, the first resin portion 3021A desirably has a degree of blackness equal to or larger than 0.7. The degree of blackness is indicated by a ratio of a maximum absorptance with respect to a minimum absorptance in the light wavelength range from 380 nm to 780 nm.

The first thickness T2A of the first resin portion 3021A desirably falls within a range from 1.1 times to a double, of the second thickness T2B of the second resin portion 3021B. If the first thickness T2A falls within the range, light rays reflected at the intersection portion and/or the corner portion inside the casing 303 can be further reduced.

The first thickness T2A of the first resin portion 3021A is not specifically limited, but desirably falls within a range from 15 μm to 750 μm. If the first thickness T2A of the first resin portion 3021A falls within the range, it is possible to achieve both of a good antireflection function and peel resistance. If the first thickness T2A of the first resin portion 3021A becomes smaller than 15 μm, there is concern that the antireflection function fails to be obtained sufficiently. On the other hand, if the first thickness T2A of the first resin portion 3021A exceeds 750 μm, film thickness unevenness is easily generated. If the film thickness unevenness becomes larger, the antireflection film 302 becomes more likely to peel from the inner wall surface of the casing 303. More desirably, the first thickness T2A of the first resin portion 3021A falls within a range from 30 μm to 250 μm.

The second resin portion 3021B is provided on the inner wall surfaces of the casing 303 except the intersection portion and the corner portion. From FIGS. 15A and 15C, it can be seen that the first resin portion 3021A and the second resin portion 3021B exist in a portion of the antireflection film 302 that is provided in close contact with the first inner wall surface 3031A.

The second resin portion 3021B has a first surface 3023B of the second resin portion 3021B, and desirably includes a protruding portion 3026B in which the deformed fiber 3022 protrudes from the first surface 3023B of the second resin portion 3021B. The first surface 3023B of the second resin portion 3021B refers to a surface of the second resin portion 3021B that is on the opposite side of a surface being in contact with the inner wall surface of the casing 303. Resin included in the second resin portion 3021B is desirably the same as resin included in the first resin portion 3021A. In addition, the first resin portion 3021A and the second resin portion 3021B are integrally formed continuously without being separated. Integrally forming the first resin portion 3021A and the second resin portion 3021B has an advantage in that the number of manufacturing processes can be reduced. Nevertheless, the first resin portion 3021A and the second resin portion 3021B need not be integrally formed.

The second thickness T2B of the second resin portion 3021B is not specifically limited, but desirably falls within a range from 10 μm to 500 μm. If the second thickness T2B of the second resin portion 3021B falls within the range, it is possible to achieve both of a good antireflection function and peel resistance. If the second thickness T2B of the second resin portion 3021B becomes smaller than 10 μm, there is concern that the antireflection function fails to be obtained sufficiently. On the other hand, if the second thickness T2B of the second resin portion 3021B exceeds 500 μm, film thickness unevenness is easily generated. If the film thickness unevenness becomes larger, the antireflection film 302 becomes more likely to peel from the inner wall surface of the casing 303. More desirably, the second thickness T2B of the second resin portion 3021B falls within a range from 20 μm to 200 μm.

The deformed fibers 3022 are bound to the first resin portion 3021A and the second resin portion 3021B. At least one of the plurality of deformed fibers 3022 protrudes from the first surface 3023A of the first resin portion 3021A at least partially. In the present disclosure, a deformed fiber refers to a fiber having a cross-sectional shape in a direction vertical to a length direction (fiber axis direction) that is other than a circle, an ellipse, and a convex polygon in which all inner angles are smaller than 180°. By the deformed fiber 3022 protruding from the first surface 3023A of the first resin portion 3021A, even if a light ray deviating from an optical path (for example, a light ray with a high incidence angle exceeding 80 degrees) enters the first surface 3023A of the first resin portion 3021A, the light ray becomes less likely to return to the optical path by impinging on the protruding deformed fiber 3022. At least one of the deformed fibers 3022 desirably protrudes from the first surface 3023B of the second resin portion 3021B at least partially. By the deformed fiber 3022 protruding from the first surface 3023B of the second resin portion 3021B, even if a light ray deviating from an optical path enters the first surface 3023B of the second resin portion 3021B, the light ray becomes less likely to return to the optical path by impinging on the protruding deformed fiber 3022.

A content of the deformed fibers 3022 per unit area of the first resin portion 3021A is desirably larger than a content of the deformed fibers 3022 per unit area of the second resin portion 3021B. This is because a generation amount of stray light can be reduced more by reducing an amount of light rays reflected at the intersection portion and/or the corner portion.

A volume of the protruding deformed fibers 3022 per unit area of the first resin portion 3021A is desirably larger than a volume of the protruding deformed fibers 3022 per unit area of the second resin portion 3021B. This is because a generation amount of stray light can be reduced more by reducing an amount of light rays reflected at the intersection portion and/or the corner portion.

A content of the deformed fibers 3022 in the antireflection film 302 desirable falls within a range from 33 parts by mass to 67 parts by mass. If the content of the deformed fibers 3022 falls within the range, the antireflection film 302 can achieve both of optical performance and manufacturing easiness. If the content of the deformed fibers 3022 is smaller than 33 parts by mass, the number of the deformed fibers 3022 protruding from the first surface 3023A of the first resin portion 3021A becomes smaller. Accordingly, there is concern that the reflectance reduction effect becomes insufficient. On the other hand, if the content of the deformed fibers 3022 exceeds 67 parts by mass, when the antireflection film 302 is formed by spray painting, the leading end of a spray nozzle becomes highly likely to be clogged, and there is concern that manufacturing becomes difficult.

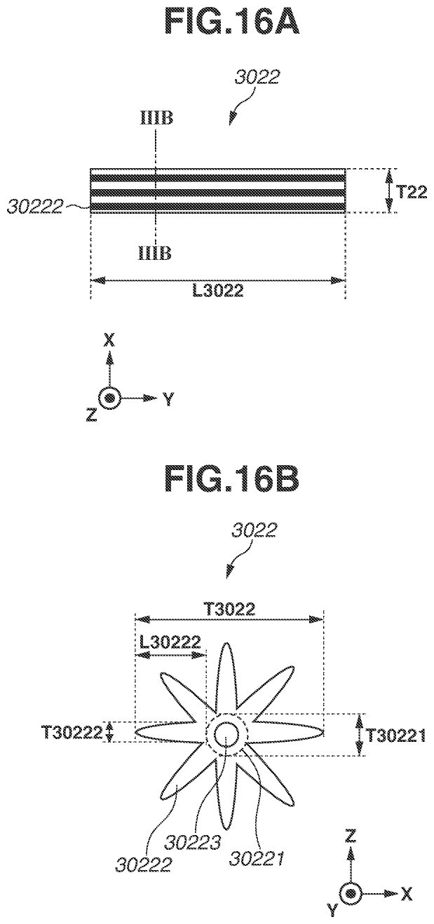

FIGS. 16A and 16B are schematic diagrams of a deformed fiber usable in the present embodiment. FIG. 16A is a plan view of the deformed fiber 3022 and FIG. 16B is a cross-sectional view of the deformed fiber 3022 that is taken along an IIIB-IIIB line in FIG. 16A.

The deformed fiber 3022 includes a core portion 30221 and a plurality of leg portions 30222 extending from the core portion 30221. The core portion 30221 is a portion drawn by a dotted line in FIG. 16B, and its cross-sectional shape is a circular shape. Nevertheless, the cross-sectional shape of the core portion 30221 need not always be a circular shape, and may be a rectangular shape. In a case where the cross-sectional shape of the core portion 30221 is a circle, a thickness T30221 of the core portion 30221 (length of a cross section in a direction vertical to a length direction of the deformed fiber 3022) indicates a diameter of the circle. In a case where the cross-sectional shape of the core portion 30221 is a polygon, the thickness T30221 indicates a diameter of an inscribed circle of the polygon. In a case where the cross-sectional shape of the core portion 30221 is an ellipse, the thickness T30221 indicates a diameter on a semimajor axis side. The core portion 30221 may include a hole 30223.

A length L3022 of the deformed fiber 3022 desirably falls within a range from 0.2 mm to 1.0 mm. If the length L3022 of the deformed fiber 3022 falls within the range, the antireflection function improves. If the length L3022 of the deformed fiber 3022 is shorter than 0.2 mm, a higher proportion of a cut surface of the deformed fiber 3022 that does not include the antireflection function protrudes from the first surface 3023A of the first resin portion 3021A. Accordingly, there is concern that the antireflection function becomes insufficient. On the other hand, if the length L3022 of the deformed fiber 3022 is longer than 1.0 mm, there is concern that it becomes difficult to cause the leg portions 30222 of the deformed fiber 3022 to protrude from the first surface 3023A of the first resin portion 3021A when the antireflection film 302 is formed. The length L3022 of the deformed fiber 3022 can be set to a desired length by cutting the deformed fiber 3022 using a cutting machine.

A thickness T3022 of the deformed fiber 3022 desirably falls within a range from 10 μm to 50 μm. The thickness T3022 of the deformed fiber 3022 refers to a length of a cross section in a direction vertical to a length direction of the deformed fiber 3022, and refers to a length of a cross section orthogonal to a fiber axis. In other words, the thickness T3022 of the deformed fiber 3022 is a maximum value of a sum of lengths in a cross-section direction of the core portion 30221 and the leg portions 30222. If the thickness T3022 of the deformed fiber 3022 falls within the range, it is possible to achieve both of the antireflection function and manufacturing easiness. If the thickness T3022 of the deformed fiber 3022 is smaller than 10 μm, a portion protruding from the first surface 3023A of the first resin portion 3021A becomes smaller. Accordingly, there is concern that the antireflection function becomes insufficient. On the other hand, if the thickness T3022 of the deformed fiber 3022 is larger than 50 μm, there is concern that it takes time to execute a cutting process for adjusting a length.

An aspect ratio being a ratio (L3022/T3022) of the length L3022 of the deformed fiber 3022 with respect to the thickness T3022 of the deformed fiber 3022 desirably falls within a range from 4 to 100. If the aspect ratio falls within the range, it becomes easier to cause the leading end of the leg portion 30222 of the deformed fiber 3022 to protrude from the first surface 3023A of the first resin portion 3021A when the antireflection film 302 is formed. Nevertheless, if the aspect ratio becomes smaller than 4 and the shape of the deformed fiber 3022 gets closer to an isotropic shape, a cut surface of the deformed fiber 3022 becomes more likely to protrude from the first surface 3023A of the first resin portion 3021A. Accordingly, there is concern that the antireflection function becomes insufficient. On the other hand, if the aspect ratio becomes larger than 100, it becomes difficult to control the orientation of the deformed fiber 3022. Accordingly, there is concern that it becomes difficult for the leading end of the leg portion 30222 to protrude from the first surface 3023A of the first resin portion 3021A.

The leg portions 30222 extend from the core portion 30221, and are made of the same material as the core portion 30221. In FIG. 16B, the number of leg portions 30222 is eight, but the number of leg portions 30222 is not limited to eight. Among regions of the deformed fiber 3022, a region protruding from the first surface 3023A of the first resin portion 3021A desirably corresponds to the leg portions 30222. This is because, by the plurality of leg portions 30222 protruding from the first surface 3023A, light rays entering a space between two leg portions can be caused to diffuse and made less likely to return to an optical path. To diffuse light rays more efficiently between leg portions in the deformed fiber 3022, it is desirable that the number of leg portions 30222 is three or more and eight or less. As an example of a commercially available deformed fiber including eight leg portions, there is Octa® manufactured by TEIJIN FRONTIER CO., LTD. It is difficult to manufacture a deformed fiber including nine or more leg portions.

A length L30222 of the leg portions 30222 desirably falls within a range from 5 μm to 20 μm. If the length L30222 of the leg portions 30222 falls within the range, a reflectance reduction effect becomes larger. If the length L30222 of the leg portions 30222 is smaller than 5 μm, a length by which the leg portion 30222 protrudes from the first surface 3023A of the first resin portion 3021A (a length of the protruding portion 3026A) becomes shorter, and light reflection between the plurality of leg portions 30222 does not occur sufficiently. Accordingly, there is concern that the reflectance reduction effect becomes insufficient. On the other hand, if the length L30222 of the leg portions 30222 is larger than 20 μm, the leg portions 30222 incline or collapse, and a sufficient amount of light rays cannot enter a space between the plurality of leg portions 30222. Accordingly, there is concern that the reflectance reduction effect becomes insufficient. More desirably, the length L30222 of the leg portions 30222 falls within a range from 5 μm to 12.5 μm.

A thickness T30222 of the leg portions 30222 desirably falls within a range from 2 μm to 6 μm. If the thickness T30222 of the leg portions 30222 falls within the range, a reflectance reduction effect becomes larger. If the thickness T30222 of the leg portions 30222 is smaller than 2 μm, the leg portions 30222 incline or collapse, and a sufficient amount of light cannot enter a space between the plurality of leg portions 30222. Accordingly, there is concern that the reflectance reduction effect becomes insufficient. On the other hand, if the thickness T30222 of the leg portions 30222 is larger than 6 μm, an interval between the plurality of leg portions 30222 becomes smaller, and light reflection between the plurality of leg portions 30222 does not occur sufficiently. Accordingly, there is concern that the reflectance reduction effect becomes insufficient.

The material of the deformed fiber 3022 is not specifically limited. For example, the material can be selected from polyester, nylon, acrylic, polypropylene, rayon, polyethylene, polyurethane, cotton linen, knitted wool, and a combination of these. To enhance the performance of the antireflection film 302, processing, light resistance processing, softening processing, or fading resistance processing may be performed on the deformed fiber 3022. Among the above-described materials, polyester is especially desirable. This is because polyester has a small linear expansion coefficient, and can reduce stress generated in the antireflection film 302.

A method for providing the antireflection film 302 on the inner wall surface of the casing 303 is not specifically limited. Examples of the method include brush painting, spray painting, dip painting, and transfer. All of these methods are methods that use, as raw material, a paint containing uncured resin being a precursor of the first resin portion 3021A, the deformed fibers 3022, and an arbitrary solvent. From the aspect of being an easy method, it is desirable to apply the above-described paint using spray painting among the above-described methods. In addition, a method for obtaining the antireflection film 302 by curing the paint is not specifically limited, either. The paint may be dried at room temperature (for example, 23° C.±2° C.), curing may be promoted by heat, or ultraviolet light may be emitted onto the paint.

As described above, according to the display apparatus of the eleventh embodiment, stray light generated by being reflected or scattered at an intersection portion and/or a corner portion at which inner wall surfaces of a casing intersect with each other becomes less likely to return to an optical path by impinging on a deformed fiber. Consequently, an amount of stray light reaching a display region 3081 of the windshield 308 is reduced. According to the display apparatus of the eleventh embodiment, because an amount of stray light reaching the windshield 308 is reduced, it is possible to provide a display apparatus superior in quality of an image (virtual image) generated from video light.

In the eleventh embodiment, the description has been given of an case where the head-up display 3030 is installed on an automobile, but the head-up display 3030 can also be applied to another vehicle such as an electric train or an airplane. In addition, the head-up display 3030 can also be used for another use application other than vehicles. In addition, the display apparatus of the eleventh embodiment can also be applied to a display apparatus such as a projector that is to be used indoors or outdoors. The two reflecting mirrors 3051 and 3052 are provided inside the casing 303, but the number of reflecting mirrors may be one depending on the design of an optical system.

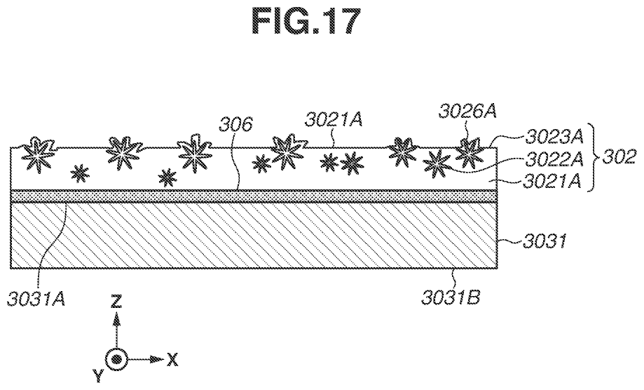

FIG. 17 is a schematic diagram illustrating an embodiment of an antireflection film included in a display apparatus according to a twelfth embodiment. The display apparatus according to the twelfth embodiment differs from that of the eleventh embodiment in that an intermediate layer 306 is provided between the first casing portion 3031 and the antireflection film 302, and the deformed fiber 3022 is covered with the first resin portion 3021A in a protruding portion 3026. Hereinafter, an optical member of the twelfth embodiment will be described mainly based on a point different from that of the eleventh embodiment.

The intermediate layer 306 is a primer layer provided on the first inner wall surface 3031A of the casing 303, for example, to enhance adhesiveness with the antireflection film 302. The material of the primer layer is not specifically limited. Examples of the material include epoxy resin, urethane resin, acrylic resin, silicone resin, and fluorine resin. The purpose of providing the intermediate layer 306 is not limited to the purpose of enhancing adhesiveness. The intermediate layer 306 may be provided for another purpose such as a purpose of preventing reaction between the first inner wall surface 3031A of the casing 303 and a precursor of the antireflection film 302 in a manufacturing process. The thickness of the primer layer is not specifically limited.

The deformed fiber 3022 is covered with the first resin portion 3021A in the protruding portion 3026. Because the deformed fiber 3022 is covered with the first resin portion 3021A in the twelfth embodiment, binding strength of the deformed fiber 3022 with respect to the first resin portion 3021A is higher than that in the eleventh embodiment. The leg portions 30222 of the deformed fiber 3022 are desirably covered with the first resin portion 3021A in the protruding portion 3026. The number of leg portions 30222 covered with the first resin portion 3021A may be one, or a plurality of leg portions 30222 may be covered with the first resin portion 3021A.

As described above, the display apparatus of the twelfth embodiment includes the protruding portion 3026 including the deformed fiber 3022 covered with the first resin portion 3021A. Thus, the display apparatus is superior to the display apparatus of the eleventh embodiment in adhesion strength of the deformed fiber 3022 with respect to the first resin portion 3021A. Accordingly, because the display apparatus of the twelfth embodiment is superior in durability to the display apparatus of the eleventh embodiment, it is possible to reduce an amount of stray light generated in an optical system, for a longer period.

### Modified Example

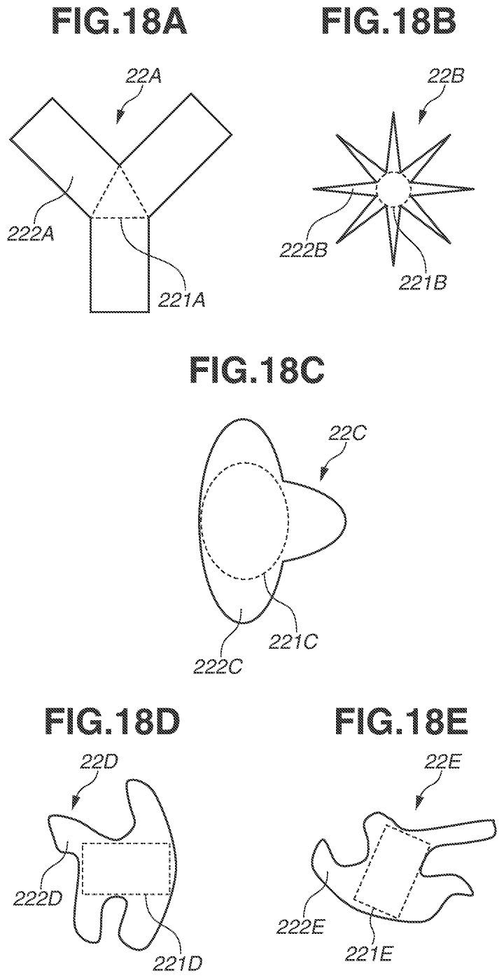

A deformed fiber is not limited to a fiber with a shape including eight leg portions that has been used in the above-described embodiments. FIGS. 18A, 18B, 18C, 18D, and 18E are schematic diagrams each illustrating a modified example of a deformed fiber.

FIG. 18A illustrates a Y-shaped deformed fiber 22A including a core portion 221A and three leg portions 222A extending from the core portion 221A. Such a configuration also has an antireflection function similar to that in the embodiments.

FIG. 18B illustrates a deformed fiber 22B including a core portion 221B and eight leg portions 222B having pointed leading ends and extending from the core portion 221B. Such a configuration also has an antireflection function similar to that in the embodiments.

FIG. 18C illustrates a deformed fiber 22C including a core portion 221C and three leg portions 222C being provided at an unequal interval and extending from the core portion 221C. Such a configuration also has an antireflection function similar to that in the embodiments.

FIG. 18D illustrates a deformed fiber 22D including a core portion 221D having a rectangular shape in a planar view, and four leg portions 222D having nonconstant sizes and extending from the core portion 221D. Such a configuration also has an antireflection function similar to that in the embodiments.

FIG. 18E illustrates a cross section of the deformed fiber 22D viewed from a different direction from FIG. 18D. In this manner, cross sections in the length direction and the vertical direction of a deformed fiber need not be all the same. Such a configuration also has an antireflection function similar to that in the first embodiment. As an example of a fiber having such a shape, there is a crimped fiber in which each thread in the fiber is crimped and wound. As an example of a commercially available crimped fiber, there is CALCULO® manufactured by TEIJIN FRONTIER CO., LTD.

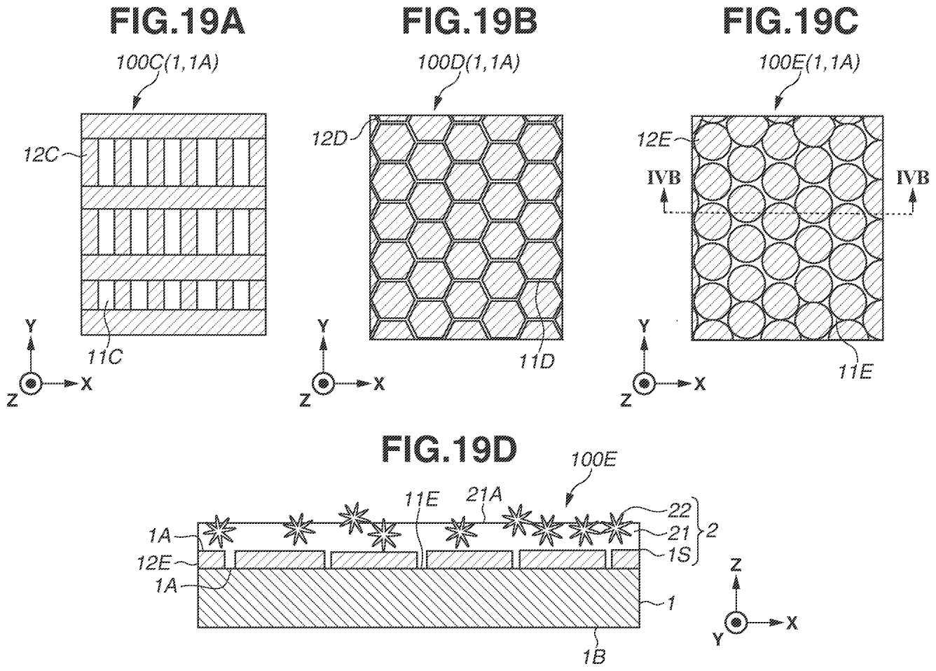

The protrusion portions 12 included in an irregular structure on a first surface of a base material are not limited to a plurality of protrusion portions 12. FIGS. 19A, 19B, 19C, and 19D are schematic diagrams each illustrating a modified example of the optical member 100.

FIG. 19A is a schematic diagram of an optical member 100C that omits the illustration of the antireflection film 2. A protrusion portion 12C of the optical member 100C has a grid-like shape in a planar view. Not a plurality of protrusion portions 12C but one protrusion portion 12C is provided. Such a configuration also has an antireflection function similar to that in the embodiments.

FIG. 19B is a schematic diagram of an optical member 100D that omits the illustration of the antireflection film 2. A protrusion portion 12D forming an embossed surface has a shape including a plurality of hexagons and being a geometric pattern in a planar view.

Such a configuration also has an antireflection function similar to that in the embodiments.

FIGS. 19C and 19D are schematic diagrams of the optical member 100E. FIG. 19C illustrates the optical member 100E while omitting the illustration of the antireflection film 2, and FIG. 19D is a cross-sectional view of the optical member 100E that is taken along an IVB-IVB line in FIG. 19C. In FIG. 19C, a protrusion portion 12E forming an embossed surface has a shape including a plurality of circular shapes, in a planar view, and employs a structure all called leather grain. The circular shape is not limited to a true circle, and may be an ellipse. In the first embodiment, the length L11 of the recess portions 11 is longer than the thickness T22 of the deformed fiber 22, but the length L11 of the recess portions 11 may be shorter than the thickness T22 of the deformed fiber 22. FIG. 19D is a schematic diagram of the optical member 100E. The optical member 100E differs from the optical member 100 illustrated in FIGS. 1A and 1B, in a length of protrusion portions and a length of recess portions. By a length L11 of recess portions 11E being shorter than the thickness T22 of the deformed fiber 22, an amount of deformed fibers 22 buried in the recess portions 11E can be reduced. It is accordingly possible to increase a proportion of the deformed fibers 22 protruding from the first surface 21A of the resin portion 21.

Protrusion portions 12E need not protrude vertically with respect to the recess portions 11E, and may protrude with forming a sharp angle or an obtuse angle.

The present disclosure is not limited to the embodiments described above, and many modifications can be made within the technical idea of the present disclosure. The effects described in the embodiments merely indicate most desirable effects produced from the present disclosure, and the effects caused by the present disclosure are not limited to those described in the embodiments.

The disclosure of the present embodiment includes the following configurations.

### (Configuration 1)

An optical member including:
a base material having a front surface; and
an antireflection film provided on the front surface of the base material and including a resin portion and a deformed fiber bound to the resin portion,
in which the antireflection film includes a protruding portion including the deformed fiber, on a surface of the resin portion that is on an opposite side of a side of the base material,
the front surface of the base material includes a protrusion portion, and
the protruding portion is provided above the protrusion portion.

### (Configuration 2)

The optical member according to Configuration 1, in which the deformed fiber is covered with the resin portion in the protruding portion.

### (Configuration 3)

The optical member according to Configuration 1 or 2, in which the front surface of the base material is an embossed surface formed by emboss processing.

### (Configuration 4)

The optical member according to any one of Configurations 1 to 3,
in which the front surface of the base material includes a recess portion,
the deformed fiber is provided above the recess portion, and
a number of deformed fibers provided above the protrusion portion is greater than a number of deformed fibers provided above the recess portion.

### (Configuration 5)

The optical member according to Configuration 4, in which a length of the recess portion is shorter than a thickness of the deformed fiber.

### (Configuration 6)

The optical member according to any one of Configurations 1 to 5, in which a thickness of the deformed fiber is larger than a height of the protrusion portion.

### (Configuration 7)

The optical member according to any one of Configurations 1 to 6, in which a length of the deformed fiber is larger than a height of the protrusion portion.

### (Configuration 8)

The optical member according to any one of Configurations 1 to 7, in which a thickness of the deformed fiber is smaller than a length of the protrusion portion.

### (Configuration 9)

The optical member according to any one of Configurations 1 to 8, in which a length of the deformed fiber falls within a range from 0.2 mm to 1.0 mm.

### (Configuration 10)

The optical member according to any one of Configurations 1 to 9, in which a thickness of the deformed fiber falls within a range from 10 μm to 50 μm.

### (Configuration 11)

The optical member according to Configuration 9 or 10, in which an aspect ratio of the deformed fiber being a ratio of a length of the deformed fiber with respect to a thickness of the deformed fiber falls within a range from 4 to 100.

### (Configuration 12)

The optical member according to any one of Configurations 1 to 11, in which the deformed fiber includes a core portion and a plurality of leg portions extending from the core portion, and a length of the leg portions falls within a range from 5 μm to 20 μm.

### (Configuration 13)

The optical member according to Configuration 12, in which the number of the leg portions is three or more and eight or less.

### (Configuration 14)

The optical member according to Configuration 12 or 13, in which at least one of the leg portions of the deformed fiber protrudes from the surface of the resin portion.

### (Configuration 15)

The optical member according to any one of Configurations 1 to 14, in which the base material includes aluminum alloy or magnesium alloy.

### (Configuration 16)

The optical member according to any one of Configurations 1 to 14, in which the base material includes resin.

### (Configuration 17)

An optical device including:
a casing; and
an optical system provided inside the casing and including at least one lens,
in which an antireflection film including a resin portion and a plurality of deformed fibers bound to the resin portion is provided on a front surface of a supporting member supporting the lens and/or an inner wall surface of the casing,
the antireflection film includes a protruding portion including the deformed fiber, on a surface of the resin portion that is on an opposite side of the front surface of the supporting member and/or the inner wall surface of the casing,
the front surface of the supporting member and/or the inner wall surface of the casing include/includes a protrusion portion, and
at least one of the deformed fibers is provided above the protrusion portion.

### (Configuration 18)

An imaging apparatus including:
a casing;
an optical system provided inside the casing and including at least one lens; and
an image sensor configured to receive light having passed through the optical system,
in which an antireflection film including a resin portion and a plurality of deformed fibers bound to the resin portion is provided on a front surface of a supporting member supporting the lens and/or an inner wall surface of the casing,
the antireflection film includes a protruding portion including the deformed fiber, on a surface of the resin portion that is on an opposite side of the front surface of the supporting member and/or the inner wall surface of the casing,
the front surface of the supporting member and/or the inner wall surface of the casing include/includes a protrusion portion, and
the protruding portion is provided above the protrusion portion.

### (Configuration 19)

A display apparatus including:
a casing;
a video generation unit provided inside the casing and configured to generate video light; and
a reflecting mirror provided inside the casing and configured to reflect video light emitted from the video generation unit and to project the reflected video light onto a display unit,
in which an antireflection film including a resin portion and a plurality of deformed fibers bound to the resin portion is provided on an inner wall surface of the casing,
the antireflection film includes a protruding portion including the deformed fiber, on a surface of the resin portion that is on an opposite side of the inner wall surface of the casing,
the inner wall surface of the casing includes a protrusion portion, and
the protruding portion is provided above the protrusion portion.

### (Configuration 20)

An optical member including:
a base material having a front surface;
an antireflection film provided on the front surface of the base material and including a resin portion, and a first deformed fiber and a second fiber bound to the resin portion,
in which the antireflection film includes a first protruding portion including the first deformed fiber, on a surface of the resin portion that is on an opposite side of a side of the base material, and
the second fiber is longer than the first deformed fiber.

### (Configuration 21)

The optical member according to Configuration 20, in which the first deformed fiber is covered with the resin portion in the first protruding portion.

### (Configuration 22)

The optical member according to Configuration 20 or 21, in which the second fiber is a second deformed fiber.

### (Configuration 23)

The optical member according to Configuration 22, in which the antireflection film includes a second protruding portion including the second deformed fiber, on the surface of the resin portion that is on the opposite side of the side of the base material.

### (Configuration 24)

The optical member according to Configuration 23, in which the second deformed fiber is covered with the resin portion in the second protruding portion.

### (Configuration 25)

The optical member according to any one of Configurations 22 to 24, in which a content of the first deformed fiber is larger than a content of the second deformed fiber in the antireflection film.

### (Configuration 26)

The optical member according to any one of Configurations 22 to 25, in which the first deformed fiber and the second deformed fiber are made of same material.

### (Configuration 27)

The optical member according to any one of Configurations 22 to 26, in which a thickness of the first deformed fiber and a thickness of the second deformed fiber are same.

### (Configuration 28)

The optical member according to any one of Configurations 20 to 27, in which a length of the first deformed fiber falls within a range from 0.2 mm to 1.0 mm, and a length of the second fiber falls within a range from 0.3 mm to 1.5 mm.

### (Configuration 29)

The optical member according to Configuration 28, in which a length of the second fiber falls within a range from 1.5 times to 5 times, of a length of the first deformed fiber.

### (Configuration 30)

The optical member according to Configuration 28 or 29, in which a thickness of the second fiber is larger than a thickness of the first deformed fiber.

### (Configuration 31)

The optical member according to any one of Configurations 28 to 30, in which a thickness of the first deformed fiber falls within a range from 10 μm to 50 μm, and a thickness of the second fiber falls within a range from 15 μm to 75 μm.

### (Configuration 32)

The optical member according to any one of Configurations 20 to 31, in which the front surface of the base material includes a protrusion portion, and the first protruding portion is provided above the protrusion portion.

### (Configuration 33)

The optical member according to Configuration 32, in which the front surface of the base material is an embossed surface formed by emboss processing.

### (Configuration 34)

The optical member according to any one of Configurations 20 to 33, in which the base material includes aluminum alloy or magnesium alloy.

### (Configuration 35)

The optical member according to any one of Configurations 20 to 33, in which the base material includes resin.

### (Configuration 36)

An optical device including:
a casing; and
an optical system provided inside the casing and including at least one lens,
in which an antireflection film including a resin portion, and a first deformed fiber and a second fiber bound to the resin portion is provided on a front surface of a supporting member supporting the lens and/or an inner wall surface of the casing,
the antireflection film includes a first protruding portion including the first deformed fiber, on a surface of the resin portion that is on an opposite side of the front surface of the supporting member supporting the lens and/or the inner wall surface of the casing, and the second fiber is longer than the first deformed fiber.

### (Configuration 37)

An imaging apparatus including:
a casing;
an optical system provided inside the casing and including at least one lens; and
an image sensor configured to receive light having passed through the optical system,
in which an antireflection film including a resin portion, and a first deformed fiber and a second fiber bound to the resin portion is provided on a front surface of a supporting member supporting the lens and/or an inner wall surface of the casing,
the antireflection film includes a first protruding portion including the first deformed fiber, on a surface of the resin portion that is on an opposite side of the front surface of the supporting member supporting the lens and/or the inner wall surface of the casing, and the second fiber is longer than the first deformed fiber.

### (Configuration 38)

A display apparatus including:
a casing;
a video generation unit provided inside the casing and configured to generate video light; and
a reflecting mirror provided inside the casing and configured to reflect video light emitted from the video generation unit and to project the reflected video light onto a display unit,
in which an antireflection film including a resin portion, and a first deformed fiber and a second fiber bound to the resin portion is provided on an inner wall surface of the casing,
the antireflection film includes a first protruding portion including the first deformed fiber, on a surface of the resin portion that is on an opposite side of the inner wall surface of the casing, and
the second fiber is longer than the first deformed fiber.

### (Configuration 39)

A display apparatus including:
a casing;
a video generation unit provided inside the casing and configured to generate video light; and
a reflecting mirror provided inside the casing and having a reflection surface configured to reflect video light emitted from the video generation unit and to project the reflected video light onto a display unit,
in which the casing has a first inner wall surface facing a first surface provided on an opposite side of the reflection surface of the reflecting mirror,
a first antireflection film including a first resin portion and a first deformed fiber bound to the first resin portion is provided on the first inner wall surface of the casing, and
the first antireflection film includes a first protruding portion including the first deformed fiber, on a surface of the first resin portion that is on an opposite side of the first inner wall surface.

### (Configuration 40)

The display apparatus according to Configuration 39, in which the first deformed fiber is covered with the first resin portion in the first protruding portion.

### (Configuration 41)

The display apparatus according to Configuration 39 or 40,
in which the casing has a second inner wall surface extending on a side of the reflection surface with forming a predetermined angle with the first inner wall surface,
a second antireflection film including a second resin portion and a second deformed fiber bound to the second resin portion is provided on the second inner wall surface, and
the second antireflection film includes a second protruding portion including the second deformed fiber, on a surface of the second resin portion that is on an opposite side of the second inner wall surface.

### (Configuration 42)

The display apparatus according to Configuration 41, in which the second deformed fiber is covered with the second resin portion in the second protruding portion.

### (Configuration 43)

The display apparatus according to Configuration 41 or 42, in which a thickness of the first resin portion is larger than a thickness of the second resin portion.

### (Configuration 44)

The display apparatus according to any one of Configurations 41 to 43, in which a content of the first deformed fiber per unit area of the first antireflection film is larger than a content of the second deformed fiber per unit area of the second antireflection film.

### (Configuration 45)

The display apparatus according to any one of Configurations 41 to 44, in which a volume of the first protruding portion is larger than a volume of the second protruding portion.

### (Configuration 46)

The display apparatus according to any one of Configurations 41 to 45, in which the first antireflection film and the second antireflection film are integrally formed.

### (Configuration 47)

The display apparatus according to any one of Configurations 39 to 46, in which a length of the first deformed fiber falls within a range from 0.2 mm to 1.0 mm.

### (Configuration 48)

The display apparatus according to any one of Configurations 39 to 47, in which a thickness of the first deformed fiber falls within a range from 10 μm to 50 μm.

### (Configuration 49)

The display apparatus according to Configuration 48, in which an aspect ratio of the first deformed fiber being a ratio of a length of the first deformed fiber with respect to a thickness of the first deformed fiber falls within a range from 4 to 100.

### (Configuration 50)

The display apparatus according to any one of Configurations 39 to 49, in which the first deformed fiber includes a first core portion and a plurality of first leg portions extending from the first core portion, and a length of the first leg portions falls within a range from 5 μm to 20 μm.

### (Configuration 51)

The display apparatus according to Configuration 50, in which the number of the first leg portions is three or more and eight or less.

### (Configuration 52)

The display apparatus according to Configuration 50 or 51, in which at least one of the first leg portions of the first deformed fiber is covered with the first resin portion in the first protruding portion.

### (Configuration 53)

The display apparatus according to any one of Configurations 41 to 46, in which the first deformed fiber and the second deformed fiber are made of same material.

### (Configuration 54)

The display apparatus according to any one of Configurations 39 to 53, in which the first inner wall surface includes a protrusion portion, and at least one of the first deformed fibers is provided above the protrusion portion.

### (Configuration 55)

The display apparatus according to Configuration 54, in which the first inner wall surface is an embossed surface formed by emboss processing.

### (Configuration 56)

The display apparatus according to any one of Configurations 39 to 55, in which the casing includes aluminum alloy or magnesium alloy.

### (Configuration 57)

The display apparatus according to any one of Configurations 39 to 55, in which the casing includes resin.

### (Configuration 58)

A display apparatus including:
a casing;
a video generation unit provided inside the casing and configured to generate video light; and
a reflecting mirror provided inside the casing and having a reflection surface configured to reflect video light emitted from the video generation unit and to project the reflected video light onto a display unit,
in which the casing has a first inner wall surface and a second inner wall surface intersecting with the first inner wall surface at a predetermined angle,
an antireflection film including a resin portion and a deformed fiber bound to the resin portion is provided astride the first inner wall surface and the second inner wall surface of the casing,
the antireflection film includes a protruding portion including the deformed fiber, on a surface of the resin portion that is on an opposite side of the first inner wall surface and the second inner wall surface, and
a first thickness of the resin portion above an intersection portion at which the first inner wall surface and the second inner wall surface intersect with each other is larger than a second thickness of the resin portion above a portion other than the intersection portion.

### (Configuration 59)

The display apparatus according to Configuration 58, in which the deformed fiber is covered with the resin portion in the protruding portion.

### (Configuration 60)

The display apparatus according to Configuration 58 or 59, in which the predetermined angle falls within a range between 0 degrees and 180 degrees, both exclusive.

### (Configuration 61)

The display apparatus according to any one of Configurations 58 to 60, in which a content of the deformed fiber per unit area of a resin portion having the first thickness is larger than a content of the deformed fiber per unit area of a resin portion having the second thickness.

### (Configuration 62)

The display apparatus according to any one of Configurations 58 to 61, in which a volume of the protruding portion in a resin portion having the first thickness is larger than a volume of the protruding portion in a resin portion having the second thickness.

### (Configuration 63)

The display apparatus according to any one of Configurations 58 to 62,
in which the casing has a third inner wall surface intersecting with the first inner wall surface and the second inner wall surface, and
a corner portion at which the first inner wall surface, the second inner wall surface, and the third inner wall surface intersect with each other is included.

### (Configuration 64)

The display apparatus according to any one of Configurations 58 to 63, in which the first thickness falls within a range from 1.1 times to a double, of the second thickness.

### (Configuration 65)

The display apparatus according to Configuration 64,
in which the first thickness falls within a range from 15 μm to 750 μm, and
the second thickness falls within a range from 10 μm to 500 μm.

### (Configuration 66)

The display apparatus according to any one of Configurations 58 to 65, in which a length of the deformed fiber falls within a range from 0.2 mm to 1.0 mm.

### (Configuration 67)

The display apparatus according to any one of Configurations 58 to 66, in which a thickness of the deformed fiber falls within a range from 10 μm to 50 μm.

### (Configuration 68)

The display apparatus according to Configuration 67, in which an aspect ratio of the deformed fiber being a ratio of a length of the deformed fiber with respect to a thickness of the deformed fiber falls within a range from 4 to 100.

### (Configuration 69)

The display apparatus according to any one of Configurations 58 to 68, in which the deformed fiber includes a core portion and a plurality of leg portions extending from the core portion, and a length of the leg portions falls within a range from 5 μm to 20 μm.

### (Configuration 70)

The display apparatus according to Configuration 69, in which the number of the leg portions is three or more and eight or less.

### (Configuration 71)

The display apparatus according to Configuration 69 or 70, in which in the protruding portion in a resin portion having the first thickness, at least one of the leg portions of the deformed fiber is covered with the resin portion.

### (Configuration 72)

The display apparatus according to any one of Configurations 58 to 71,
in which the first inner wall surface and/or the second inner wall surface includes a protrusion portion, and
at least one of the deformed fibers is provided above the protrusion portion.

### (Configuration 73)

The display apparatus according to Configuration 72, in which the first inner wall surface and/or the second inner wall surface including the protrusion portion is an embossed surface formed by emboss processing.

### (Configuration 74)

The display apparatus according to Configuration 72 or 73, in which the protrusion portion is a screw.

### (Configuration 75)

The display apparatus according to any one of Configurations 58 to 74, in which the casing includes aluminum alloy or magnesium alloy.

### (Configuration 76)

The display apparatus according to any one of Configurations 58 to 74, in which the casing includes resin.

According to the present disclosure, it is possible to provide an optical member with a low reflectance. It is also possible to provide an optical device superior in optical performance, an imaging apparatus superior in quality of a captured image, and a display apparatus superior in quality of a display image.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Applications No. 2022-012050, filed Jan. 28, 2022, No. 2022-012049, filed Jan. 28, 2022, No. 2022-012052, filed Jan. 28, 2022, No. 2022-012051, filed Jan. 28, 2022, No. 2022-202518, filed Dec. 19, 2022, No. 2022-202519, filed Dec. 19, 2022, No. 2022-202520, filed Dec. 19, 2022, and No. 2022-202521, filed Dec. 19, 2022, which are hereby incorporated by reference herein in their entirety.

What is claimed is:

1. An optical member comprising:
a base material having a front surface; and
an antireflection film provided on the front surface of the base material and including a resin portion and a deformed fiber bound to the resin portion,
wherein the antireflection film includes a protruding portion including the deformed fiber, on a surface of the resin portion that is on an opposite side of a side of the base material,
wherein the front surface of the base material includes a protrusion portion, and
wherein the protruding portion is provided above the protrusion portion.

2. The optical member according to claim 1, wherein the deformed fiber is covered with the resin portion in the protruding portion.

3. The optical member according to claim 1, wherein the front surface of the base material is an embossed surface formed by emboss processing.

4. The optical member according to claim 1,
wherein the front surface of the base material includes a recess portion,
wherein the deformed fiber is provided above the recess portion, and
wherein a number of deformed fibers provided above the protrusion portion is greater than a number of deformed fibers provided above the recess portion.

5. The optical member according to claim 4, wherein a length of the recess portion is shorter than a thickness of the deformed fiber.

6. The optical member according to claim 1, wherein a thickness of the deformed fiber is larger than a height of the protrusion portion.

7. The optical member according to claim 1, wherein a length of the deformed fiber is larger than a height of the protrusion portion.

8. The optical member according to claim 1, wherein a thickness of the deformed fiber is smaller than a length of the protrusion portion.

9. The optical member according to claim 1, wherein the deformed fiber includes a core portion and a plurality of leg portions extending from the core portion, and a length of the leg portions falls within a range from 5 μm to 20 μm.

10. The optical member according to claim 9, wherein at least one of the leg portions of the deformed fiber protrudes from the surface of the resin portion.

11. The optical member according to claim 1, wherein the base material includes aluminum alloy or magnesium alloy.

12. An optical member comprising:
a base material having a front surface; and
an antireflection film provided on the front surface of the base material and including a resin portion, and a first deformed fiber and a second fiber bound to the resin portion,
wherein the antireflection film includes a first protruding portion including the first deformed fiber, on a surface of the resin portion that is on an opposite side of a side of the base material, and
wherein the second fiber is longer than the first deformed fiber.

13. The optical member according to claim 12, wherein the first deformed fiber is covered with the resin portion in the first protruding portion.

14. The optical member according to claim 12, wherein the second fiber is a second deformed fiber.

15. The optical member according to claim 14, wherein the antireflection film includes a second protruding portion including the second deformed fiber, on the surface of the resin portion that is on the opposite side of the side of the base material.

16. The optical member according to claim 15, wherein the second deformed fiber is covered with the resin portion in the second protruding portion.

17. The optical member according to claim 14, wherein a content of the first deformed fiber is larger than a content of the second deformed fiber in the antireflection film.

18. An optical device comprising:
a casing; and
an optical system provided inside the casing and including at least one lens,
wherein the optical member according to claim 1 is provided on an inner wall surface of the casing.

19. A display apparatus comprising:
a casing;
a video generation unit provided inside the casing and configured to generate video light; and
a reflecting mirror provided inside the casing and configured to reflect video light emitted from the video generation unit and to project the reflected video light onto a display unit,
wherein the optical member according to claim 1 is provided on an inner wall surface of the casing.

20. An optical device comprising:
a casing; and
an optical system provided inside the casing and including at least one lens,
wherein the optical member according to claim 12 is provided on an inner wall surface of the casing.

21. A display apparatus comprising:
a casing;
a video generation unit provided inside the casing and configured to generate video light; and
a reflecting mirror provided inside the casing and configured to reflect video light emitted from the video generation unit and to project the reflected video light onto a display unit,
wherein the optical member according to claim 12 is provided on an inner wall surface of the casing.

22. A display apparatus including:
a casing;
a video generation unit provided inside the casing and configured to generate video light; and
a reflecting mirror provided inside the casing and having a reflection surface configured to reflect video light emitted from the video generation unit and to project the reflected video light onto a display unit,
wherein the casing has a first inner wall surface facing a first surface provided on an opposite side of the reflection surface of the reflecting mirror,
wherein a first antireflection film including a first resin portion and a first deformed fiber bound to the first resin portion is provided on the first inner wall surface of the casing, and
wherein the first antireflection film includes a first protruding portion including the first deformed fiber, on a surface of the first resin portion that is on an opposite side of the first inner wall surface.

23. The display apparatus according to claim 22, wherein the first deformed fiber is covered with the first resin portion in the first protruding portion.

24. The display apparatus according to claim 22,
wherein the casing has a second inner wall surface extending on a side of the reflection surface with forming a predetermined angle with the first inner wall surface,
wherein a second antireflection film including a second resin portion and a second deformed fiber bound to the second resin portion is provided on the second inner wall surface, and
wherein the second antireflection film includes a second protruding portion including the second deformed fiber, on a surface of the second resin portion that is on an opposite side of the second inner wall surface.

25. The display apparatus according to claim 24, wherein the second deformed fiber is covered with the second resin portion in the second protruding portion.

26. The display apparatus according to claim 24, wherein a thickness of the first resin portion is larger than a thickness of the second resin portion.

27. The display apparatus according to claim 24, wherein a content of the first deformed fiber per unit area of the first antireflection film is larger than a content of the second deformed fiber per unit area of the second antireflection film.

28. The display apparatus according to claim 24, wherein a volume of the first protruding portion is larger than a volume of the second protruding portion.

29. The display apparatus according to claim 24, wherein the first antireflection film and the second antireflection film are integrally formed.

30. A display apparatus including:
a casing;
a video generation unit provided inside the casing and configured to generate video light; and
a reflecting mirror provided inside the casing and having a reflection surface configured to reflect video light emitted from the video generation unit and to project the reflected video light onto a display unit,
wherein the casing has a first inner wall surface and a second inner wall surface intersecting with the first inner wall surface at a predetermined angle,
wherein an antireflection film including a resin portion and a deformed fiber bound to the resin portion is provided astride the first inner wall surface and the second inner wall surface of the casing,
wherein the antireflection film includes a protruding portion including the deformed fiber, on a surface of the resin portion that is on an opposite side of the first inner wall surface and the second inner wall surface, and
wherein a first thickness of the resin portion above an intersection portion at which the first inner wall surface and the second inner wall surface intersect with each other is larger than a second thickness of the resin portion above a portion other than the intersection portion.

31. The display apparatus according to claim 30, wherein the deformed fiber is covered with the resin portion in the protruding portion.

32. The display apparatus according to claim 30, wherein the predetermined angle falls within a range between 0 degrees and 180 degrees, both exclusive.

33. The display apparatus according to claim 30, wherein a content of the deformed fiber per unit area of a resin portion having the first thickness is larger than a content of the deformed fiber per unit area of a resin portion having the second thickness.

34. The display apparatus according to claim 30, wherein a volume of the protruding portion in a resin portion having the first thickness is larger than a volume of the protruding portion in a resin portion having the second thickness.

35. The display apparatus according to claim 30,
wherein the casing has a third inner wall surface intersecting with the first inner wall surface and the second inner wall surface, and
wherein a corner portion at which the first inner wall surface, the second inner wall surface, and the third inner wall surface intersect with each other is included.

36. The display apparatus according to claim 30, wherein the first thickness falls within a range from 1.1 times to a double, of the second thickness.
